(19) United States
(12) Patent Application Publication
(10) Pub. No.: US 2025/0372080 A1
(43) Pub. Date: Dec. 4, 2025

(54) SPEECH RECOGNITION MODEL TRAINING AND SPEECH RECOGNITION

(71) Applicant: MASHANG CONSUMER FINANCE CO., LTD., Chongqing (CN)

(72) Inventor: Qinglin MENG, Chongqing (CN)

(73) Assignee: MASHANG CONSUMER FINANCE CO., LTD., Chongqing (CN)

(21) Appl. No.: 19/227,449

(22) Filed: Jun. 3, 2025

(30) Foreign Application Priority Data
Jun. 4, 2024 (CN) 202410718896.0

(51) Int. Cl. G10L 15/06; G10L 15/16

(52) U.S. Cl. CPC G10L 15/063; G10L 15/16

(57) ABSTRACT

A method of training a speech recognition model having an encoder includes: obtaining an encoded vector sequence obtained by the encoder processing a speech sequence sample; decoding the encoded vector sequence by a decoding network to obtain a decoded vector sequence; performing vector fusion on the encoded vector sequence and the decoded vector sequence by the decoding network to obtain a fused vector sequence; performing mapping processing on the fused vector sequence by the decoding network to obtain a mapped vector sequence; determining a first loss for the speech sequence sample based on the mapped vector sequence and a label sequence of the speech sequence sample; and adjusting network parameters of the encoder based on the first loss to train the speech recognition model.

### CROSS-REFERENCE TO RELATED APPLICATION

This application claims priority to and the benefit of Chinese Patent Application No. 202410718896.0, filed on Jun. 4, 2024, the disclosure of which is incorporated herein by reference in its entirety.

### TECHNICAL FIELD

The present disclosure relates to artificial intelligence technologies, and more particularly, to speech recognition model training, and speech recognition.

### BACKGROUND

Human speech may be converted into text by speech recognition. Generally, a neural network model for end-to-end speech recognition is used to perform automatic speech recognition. In some cases, the end-to-end speech recognition may further employ a fully neural network-based approach. In the end-to-end speech recognition, the capability of an encoder is critical to the effect of the speech recognition.

### SUMMARY

In view of the above, some embodiments of the present disclosure provide a method of training a speech recognition model, including: obtaining an encoded vector sequence obtained by the encoder processing a speech sequence sample; decoding the encoded vector sequence by a decoding network to obtain a decoded vector sequence; performing vector fusion on the encoded vector sequence and the decoded vector sequence by the decoding network to obtain a fused vector sequence; performing mapping processing on the fused vector sequence by the decoding network to obtain a mapped vector sequence; determining a first loss for the speech sequence sample based on the mapped vector sequence and a label sequence of the speech sequence sample; and adjusting network parameters of the encoder based on the first loss to train the speech recognition model.

Some embodiments of the present disclosure provide a speech recognition method, including: encoding a target speech sequence by an encoder of a speech recognition model to obtain a target encoded vector sequence, the speech recognition model being trained by the above training method; and performing text recognition on the target encoded vector sequence by a decoder of the speech recognition model to obtain a predicted text corresponding to the target speech sequence.

Some embodiments of the present disclosure provide a computer device. The computer device includes a processor and a memory storing instructions executable by the processor to perform the above method of training a speech recognition model or to perform the above speech recognition method.

Some embodiments of the present disclosure provide a non-transitory computer-readable storage medium storing instructions executable by a processor to perform the above method of training a speech recognition model or to perform the above speech recognition method.

Some embodiments of the present disclosure provide a computer program product including a computer program executable by a processor to perform the above method of training a speech recognition model or to perform the above speech recognition method.

### BRIEF DESCRIPTION OF THE DRAWINGS

FIG. 1 schematically shows an environment where a method of training a speech recognition model according to some embodiments of the present disclosure and a speech recognition method according to some embodiments of the present disclosure may be applied.

FIG. 2 schematically shows a scenario where a speech recognition method according to some embodiments of the present disclosure may be applied.

FIG. 3 is a block diagram of an intelligent outbound calling system which may be used in a speech recognition method according to some embodiments of the present disclosure.

FIG. 4 is a schematic flowchart of a method of training a speech recognition model according to some embodiments of the present disclosure.

FIG. 5 is a schematic block diagram of an encoder of a speech recognition model according to some embodiments of the present disclosure.

FIG. 6 schematically shows a structure of a speech recognition model according to some embodiments of the present disclosure.

FIG. 7 is a schematic graph of vector similarity of a decoding network according to some embodiments of the present disclosure.

FIG. 8 is a schematic graph of a spike during training of a speech recognition model according to some embodiments of the present disclosure.

FIG. 9 is a schematic flowchart of a speech recognition method according to some embodiments of the present disclosure.

FIG. 10 schematically shows another structure of a speech recognition model according to some embodiments of the present disclosure.

FIG. 11 is a schematic block diagram of an apparatus for training a speech recognition model according to some embodiments of the present disclosure.

FIG. 12 is a schematic block diagram of a speech recognition apparatus according to some embodiments of the present disclosure.

FIG. 13 is a schematic block diagram of a computer device according to some embodiments of the present disclosure.

### DETAILED DESCRIPTION

Some embodiments of the present disclosure will be described in detail below with reference to the accompanying drawings. The embodiments are described for illustrative purposes only and are not intended to limit the present disclosure.

The terms “first” and “second” are used for distinguishing descriptions only and are not to be construed as indicating or imposing a relative importance. The word “a” or “an” means at least one, and “a plurality of” means two or more, unless otherwise specifically defined.

The training method or the speech recognition method for the speech recognition model according to an embodiment of the present disclosure may be run on a local terminal device or a server. When the training method or the speech recognition method for the speech recognition model is run on the server, the training method or the speech recognition method for the speech recognition model may be implemented and executed based on a cloud-based interaction system including the server and the client end device.

In order to better understand a training method, a speech recognition method, an apparatus, a device, and a medium for a speech recognition model according to some embodiments of the present disclosure, an application environment applicable to the embodiment of the present disclosure is described below.

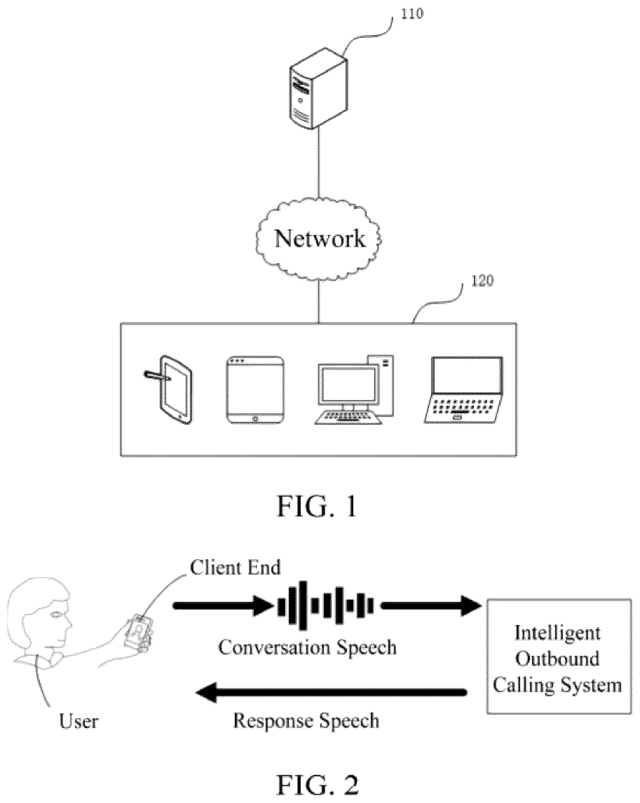

In an implementation, referring to FIG. 1, a training method and a speech recognition method for a speech recognition model according to some embodiments of the present disclosure may be applied to the same computer device or in the same computer device. Here, the computer device may be a server 110 as shown in FIG. 1, and the server 110 may be connected to a terminal device 120 through a network. The network serves as a medium for providing a communication link between the server 110 and the terminal device 120. The network may include various connection types, such as a wired communication link, a wireless communication link, or the like, and the connection type in the embodiments of the present disclosure is not limited hereto. Alternatively, in other embodiments, the computer device may be a terminal device, such as a smartphone, a notebook computer, or the like.

It should be understood that the server 110, network, and terminal device 120 in FIG. 1 are merely illustrative. The number of servers, networks, and/or terminal devices may be determined as desired. Exemplarily, the server 110 may be a physical server, a server cluster formed of a plurality of servers, or the like, and the terminal device 120 may be a mobile phone, a tablet, a desktop computer, a notebook computer, or the like, and the terminal device 120 may include a client end of FIG. 2. It will be appreciated that a plurality of terminal devices 120 may simultaneously access the server 110 in some embodiments of the present disclosure.

In some embodiments, the terminal device 120 may record the speech of the user to obtain a speech signal stream for the user. Further, the terminal device 120 transmits the speech signal stream for the user to the server 110 through the network. After the server 110 receives the speech signal stream for the user, the terminal device 120 may process the speech signal stream through the speech recognition model according to some embodiments of the present disclosure.

In another implementation, the training method and the speech recognition method for the speech recognition model according to some embodiments of the present disclosure may be applied into different computer devices. For example, the method of training the speech recognition model is applied to a computer device, and the speech recognition method is applied to another computer device, etc. The computer equipment to which the above methods are applied in some embodiments of the present disclosure is not limited hereto.

Detailed description will be provided below with reference to the accompanying drawings. In some embodiments, the execution body is a terminal device as an example. It should be noted that the order in which the following embodiments are described is not intended to limit the preferred order of the embodiments. Although a logical order is shown in the flowchart, in some cases, the illustrated or described steps may be performed in an order different from that shown in the flowchart.

The training method or the speech recognition method for the speech recognition model according to an embodiment of the present disclosure may be applied to a product of a scene of any speech recognition, such as an intelligent outbound calling system in the server.

The intelligent outbound calling system may obtain a speech signal stream for a user, perform speech recognition processing on the speech signal stream to obtain a predicted text, then perform intent analysis on the predicted text to obtain an intent recognition result, then generate a speech text for responding to a user's speech based on the intent recognition result, finally perform speech synthesis based on the speech text to obtain a response speech, and then trigger an intelligent robot in the terminal device to respond according to the response speech to realize a response cycle.

As an example, FIG. 2 shows an application scenario to which a speech recognition method according to some embodiments is applied. The application scenario includes: collecting a conversation speech (or speech signal stream) during a conversation between a user and an intelligent robot by using the client end, sending the conversation speech to an intelligent robot conversation system (e.g., the intelligent outbound calling system) for processing, and obtaining a response speech to be output to the user.

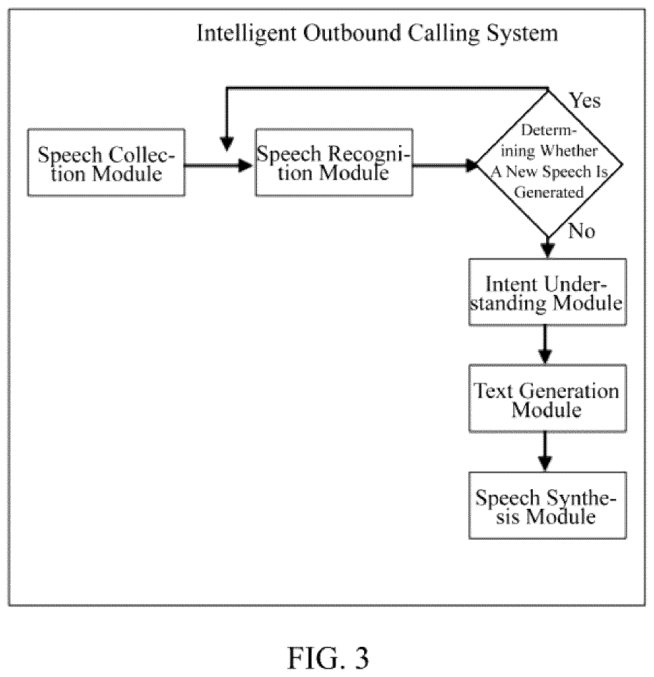

As an example, referring to FIG. 3, first, the intelligent outbound calling system obtains a user's speech signal stream through a speech collection module in the intelligent outbound calling system and the obtaining of the user's speech signal stream may include: receiving a speech signal stream and transmitted in real time from a client end by the user by using a media resource control protocol (MRCP). Then, the speech signal stream is input to a speech recognition module (that is, a speech recognition model according to an embodiment of the present disclosure). In particular, first, an endpoint detection function module and an intermediate result generation module in the speech recognition module are configured to determine whether an intermediate result is generated. Under the condition that the intermediate result is generated, the intelligent outbound calling system triggers a robot interruption mechanism, pauses the current reply and continues to receive the user's speech sequence, and repeats this process until no intermediate result is generated. Under the condition that no intermediate result is generated, the speech recognition module is configured to perform fast decoding on the speech sequence to generate an output result (or predicted text). The output result is input to an intent understanding (or intent recognition) module, determination is performed based on intent understanding, the determination logic is corresponding to the response for reply, a response text to be synthesized is generated by the text generation module, and input to the speech synthesis module. The speech synthesis module generates a speech text for responding to a user's speech based on the response text, and a response cycle is realized. In this way, the characters may be quickly and effectively recognized, the translation efficiency and accuracy requirements of the intelligent outbound calling may be met, and the utilization of the resources by the training model may be effectively reduced.

In the related art, although an autoregressive decoding has the relatively higher accuracy, it is the more time-consuming, and it is difficult to achieve an expected effect in a streaming decoding scenario in which the real-time requirement is relatively high. On the other hand, non-autoregression decoding with attention rescoring achieves a relatively accurate effect. However, in a streaming inference scenario, rescoring can be only performed by the user after obtaining all the streaming recognition intermediate results, and the user needs to wait for the inference time of attention decoder (attention decoder), so that when the streaming interaction system is applied, the user needs to wait for even 3 s to 4 s, resulting in poor user experience. However, if a decoder is used alone to perform connectionist temporal classification (CTC) decoding, the delay will be greatly shortened, and the system will also reach a delay level acceptable to the user. However, if CTC streaming decoding is used alone, the accuracy is often poor.

Based on the above effects, some embodiments of the present disclosure additionally provide an additional decoding network on a basis of the Transformer (attention mechanism based deep learning model) decoder with the attention loss. Then, the output of the encoder is input to the decoding network, and then the output of the encoder is encoded by the decoding network and then the encoded output is fused with the output of the encoder to obtain a fused result. The loss is calculated based on the fused result to adjust the parameters of the model in the encoder so that the encoder may learn a portion of the knowledge of the decoding network and improve the context information capability of the encoder, thereby improving the end-to-end speech recognition capability of the speech recognition model.

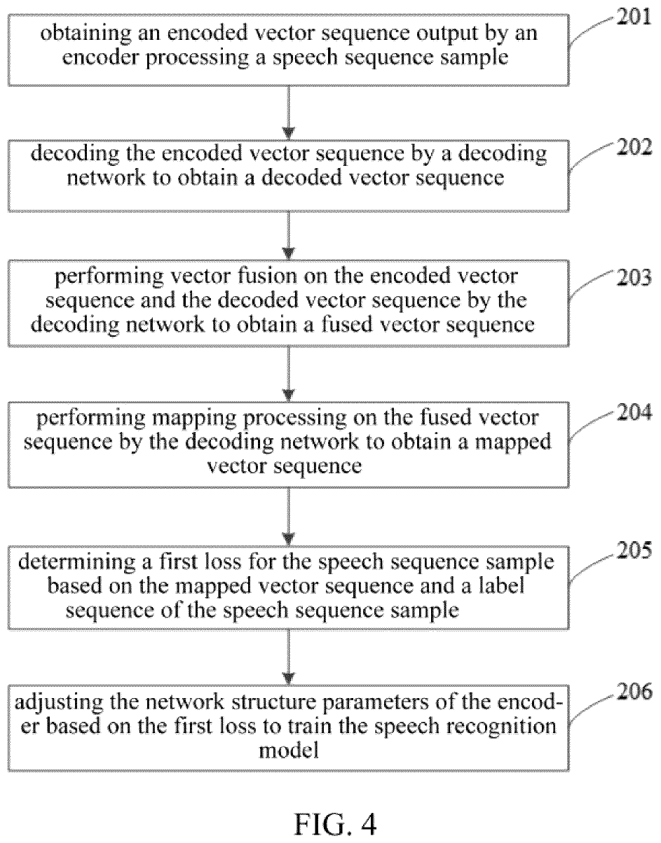

FIG. 4 is a schematic flowchart of a method of training a speech recognition model according to some embodiments of the present disclosure. The method of training the speech recognition model includes Step 201 to Step 206.

At Step 201, an encoded vector sequence obtained by an encoder of the speech recognition model processing a speech sequence sample.

The speech recognition model may be a pre-constructed foundation model for speech recognition, and the speech sequence sample may be used to train the speech recognition model to obtain a speech recognition model with better speech recognition accuracy.

In an embodiment of the present disclosure, a speech sequence sample refers to a speech sequence for training a speech recognition model, and the speech sequence sample may be obtained from a preset speech corpus, for example, the preset speech sequence set may include the AiShell corpus, the LibriSpeech corpus, or the like.

The AiShell corpus (or AiShell dataset) is a Chinese speech corpus mainly used for model training and related research. The AiShell corpus includes a large amount of Chinese speech data covering different accents and dialects to optimize the Chinese model. The LibriSpeech corpus (or LibriSpeech dataset) is a widely used open-source dataset for model training and used mainly to evaluate the performance of a trained model. The LibriSpeech corpus contains approximately 1,000 hours of English speech recordings from the audiobook website, containing various types of audiobooks read by multiple speakers. These corpus are organized as book chapters containing text and speech.

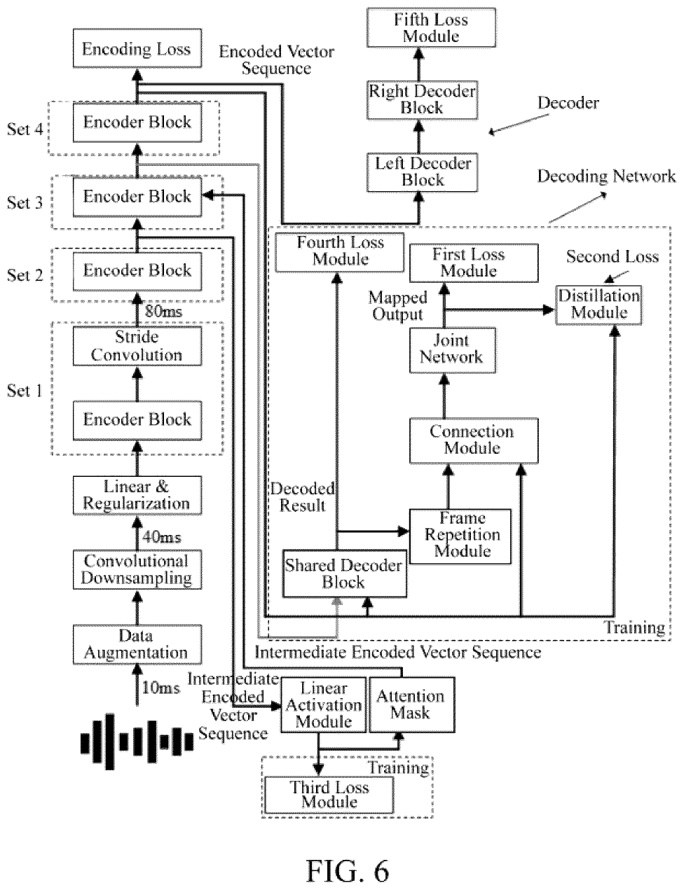

The encoder may be a network structure for performing encoding processing in a speech recognition model. In an embodiment, the encoder may include an encoder including sets 1 to 4 as shown in FIG. 6 and have the architecture as shown in FIG. 6.

The encoder may be a neural network that may be configured to convert input data, such as texts, images or sequences, into a fixed-size vector representation (also be called embedding or encoding). This vector representation may capture a key vector or information of input data for subsequent tasks (e.g., classification, generation, translation, etc.).

In an embodiment of the present disclosure, the training employs the Conformer-Transformer model, where the encoder may employ the Conformer model and the decoder employs the Transformer model. The encoder may employ encoder in Efficient Conformer. The Efficient Conformer is an improved speech recognition model, which is an optimized version of the Conformer model. The Conformer model is a language model that combines the advantages of the Transformer model and the convolutional neural network (CNN). The Attention mechanism is used to construct a new deep neural network structure, which may better capture long-term dependencies in the text. The Transformer model is a deep learning model based on Self-Attention mechanism.

Here, the speech sequence samples are encoded by the encoder, that is, the speech sequence samples are converted into one or more vector representations by the encoder, and the vector representation may capture different aspects of the audio signal (or be called speech sequence sample), such as the spectrum, the rhythm, and the timbre.

In some embodiments, the encoder may perform encoding processing by preprocessing, time domain analysis, frequency domain analysis, or other advanced encoding processes.

Preprocessing: First, some preprocessing operations such as framing, windowing, pre-emphasis, etc. are performed on the speech sequence sample for subsequent encoding processing and analysis.

Time domain analysis: Audio signals are analyzed directly in the time domain. Statistical vectors of the audio signal, such as means, variances, peaks, and the like, as well as dynamic vectors, such as Zero Crossing Rate (ZCR), Short Time Energy (STE), and the like, may be extracted, the statistical vectors and the dynamic vectors may reflect the variation characteristics of the audio signal in the time domain.

Frequency domain analysis: Frequency domain analysis is an analysis that converts an audio signal from the time domain to the frequency domain. The frequency domain analysis includes Fourier Transform (FT) and variants thereof such as Short Time Fourier Transform (STFT). By these methods, the frequency spectrum of the audio signal, i.e., the strength of the audio signal at respective ones of frequencies, may be obtained.

Other advanced encoding processes: In addition to the time domain vector and frequency domain vector described above, more advanced encoding processes such as Mel-Frequency Cepstral Coefficients (MFCCs) or deep learning models (e.g., convolutional neural network CNN, cyclic neural network RNN, etc.) may be used to extract audio vectors. The extracted advanced vector is capable of capturing more complex and abstract characteristics of the audio signals.

The encoded vector sequence refers to a sequence formed of encoded vectors obtained by performing encoding processing on an input speech sequence sample by the encoder of the speech recognition model in the manner described above.

In an embodiment of the present disclosure, the speech recognition model may further include a decoder that may be configured to process the output of the encoder to obtain the predicted texts of the speech sequence samples.

For example, the speech sequence is input to a speech recognition model, the speech sequence is encoded by the encoder of the speech recognition model to obtain a final encoded vector sequence, and then the final encoded vector sequence is decoded by the decoder to obtain the predicted text corresponding to the speech sequence.

The decoder may be a network structure for decoding processing in the speech recognition model.

The decoder may be configured to decode the context vector or the encoded vector generated by the encoder into the output sequence. The decoding process may be implemented by using a architecture such as a recurrent neural network (RNN), long short-term memory network (LSTM), or a gated recurrent unit (GRU).

In an embodiment of the present disclosure, the decoder may employ the decoder in the Transformer model (or be called Transformer decoder).

The final encoded vector sequence output by the encoder is decoded by the decoder, that is, the final encoded vector sequence is decoded into the predicted text by the Transformer decoder.

In some embodiments, the decoding processing of the Transformer decoder may include initializing decoder parameters, preparing input data, a Self-Attention layer, an encoder-decoder attention layer, a Feed Forward Neural Network, generating output, and iteration.

Initializing the decoder parameters: Parameters of the decoder need to be initialized first. The decoder parameters include the number of decoder layers, the number of hidden units per decoder layer, the number of attention heads, and the like.

Preparing input data: The input of the decoder includes a semantic representation output by the encoder (also be called a context vector or encoded vector) and a start token. The start token is a special flag for indicating the start of the decoding process.

Self-attention layer: The first layer in the decoder is the Self-Attention layer. The Self-Attention layer allows the decoder to attend to the previously generated portion of the sequence when generating the output sequence, taking the previous information into account when generating the output of the current position.

Encoder-decoder attention layer: The Encoder-decoder attention layer follows the attention layer. The Encoder-decoder attention layer allows the decoder to attend to the semantic representation output by the encoder, thereby capturing the relevant information in the input sequence.

Feed Forward Neural Network: After the encoder-decoder attention layer, the output of the decoder is further processed through a Feed Forward Neural Network (FFNN). This FFNN layer may perform a non-linear transformation on the output of the decoder to improve the representation capability of the model.

Generating output: At each time step, the decoder generates an output. This output at each time step is calculated based on the output of the previous time step, the hidden state, and the input of the current time step. In the generating of the output, the decoder may calculate the probability for each word in the output vocabulary by using a softmax function and select the word with the highest probability as the output.

Iteration: The decoder repeats the above steps until the complete output sequence is generated or a preset maximum length is reached. At each time step, the decoder updates its hidden state and output based on the previous output and the current input.

At Step 202, the encoded vector sequence is decoded through a decoding network to obtain a decoded vector sequence.

Here, on the basis of a transformer decoder in the speech recognition model, an additional branch called prediction decoder network (or be called predict network, i.e., pred network) is added in the speech recognition model, the prediction decoder network has the same number of parameters as the currently transformer decoder. In other words, the prediction decoder network refers to an additional network (predict network,) added into the speech recognition model for decoding the encoded vector sequence (output of the encoder). The pred network may use the Transformer decoder as the underlying network structure, that is, the pred network includes a decoder block (such as a shared decoder block in FIG. 6) of the Transformer network as the network structure in the pred network for implementing a decoding function. The pred network not only uses attention loss but also combines its output (or the decoded result, y_{dec_pred}) with the encoder's output (or encoded vector sequence, y_{enc}).

In an embodiment, the output of the pred network is repeated so that the dimension of the repeated decoded result is the same as the dimension of the decoded vector sequence. The repeated decoded result and the decoded vector sequence are fused to obtain a fused vector sequence. The fused vector sequence is mapped by a joint network to obtain a mapped vector sequence corresponding to the fused vector sequence. The CTC loss of the pred network may be calculated based on the mapped vector sequence as the first loss for the speech sequence sample. Thus the context information capability of the encoder may be improved.

Further, in order to supervise an intermediate network layer of the Conformer encoder, in the speech recognition model, the predictive decoder network may further configured to decode the intermediate network layer (for example, the 6th, 8th and/or 9th layer of the 12-layer decoder) of the Conformer encoder to standardize parameters of the intermediate network layer and improve the semantic information of the intermediate network layer. In other words, the predictive decoder network for decoding the intermediate network layer of the Conformer encoder shares parameters with the predictive decoder network for decoding the output of the encoder, so the predictive decoder network here may be named a shared predictive decoding network or the decoding network below. A detailed description will be given below.

In some embodiments, the pred network may include a shared decoder block that may be configured to decode the encoded vector sequence to obtain the decoded vector sequence.

The shared decoder block includes the Transformer decoder blocks. In this case, the decoding of the encoded vector sequence by the shared decoder block may include: decoding the encoded vector sequence by the decoder blocks, to obtain the decoded vector sequence.

The decoded vector sequence refers to a predicted label sequence obtained after decoding the encoded vector sequence by the decoder block.

In some embodiments, the decoder block may include two main sublayers: a Multi-Head Self-Attention sublayer and a Feed-Forward Neural Network sublayer. Residual Connection and layer Normalization operations are performed on both the input and output of each sublayer, to facilitating gradient propagation.

The decoding process of the decoder block may include input data, a Self-Attention mechanism, a Feed Forward Neural Network, and output data.

Input data: Input data includes the output of the encoder and positional encoding. The positional encoding is used to introduce information about each position in the sequence into the Self-Attention mechanism, thereby solving the problem of missing positional information in the Transformer model itself.

Self-attention mechanism: In the Self-Attention mechanism, the decoder predicts the next output in consideration of the entire input sequence as well as the portion of the target sequence that has been generated.

Feed Forward Neural Network: After Self-Attention mechanism processing, the processed output is sent to the Feed Forward Neural Network for further processing. The Feed Forward Neural Network includes two linear transformations and a ReLU activation function.

Output data: a linear layer is connected after the decoder layer for converting the output of the decoder into a final target sequence.

In some embodiments, the encoder may include a plurality of sequentially connected network layers, and the encoded vector sequence includes a first encoded vector sequence output by the first network layer in the encoder and a second encoded vector sequence output by the second network layer in the encoder. The second network layer may be the last network layer of the encoder. Then, the decoding of the encoded vector sequence through the decoding network to obtain the decoded vector sequence may include: decoding the first encoded vector sequence output by the first network layer of the encoder by the decoding network to obtain a first decoded vector sequence.

The encoder includes a plurality of sequentially connected network layers and the encoder may further include a plurality of encoder blocks, i.e., Conformer Block modules. For the encoder blocks, each encoder block may include at least one of the network layers.

The encoder includes a plurality of encoder blocks. These encoder blocks are similar in structure and are stacked together to form a deeper network structure. That is, the output of each encoder block is used as the input to the next encoder block, thereby progressively forming a deeper network structure. In this way, the model may capture more advanced and more complex vectors in the input sequence, thereby improving its performance for various tasks. Although the plurality of encoder blocks in the encoder are similar in structure, they learn different vector representations during training. This is because each encoder block is adjusted and optimized based on the output of the previous encoder block, thereby gradually obtaining a vector representation that is more suitable for the current task.

In some embodiments, the encoder may be an encoder in Conformer model, i.e., a Conformer block. The Conformer block may include four sub-modules, i.e., a Feed Forward module, a Multi-Head Self-Attention module, a Convolution module, and Another Feed Forward Module. The Feed Forward module is a fully connected Feed Forward Neural Network, for performing non-linear transformation on the representation of each position. The Multi-Head Self-Attention module allows the model to process the dependencies in the input sequence regardless of how far away these dependencies are in the sequence. By calculating attention weights between different positions in the input sequence, the model may learn and attend to the information most relevant to the current position. The convolution module introduces features of a Convolution neural network to capture local vectors in the input sequence. The convolution operation may help the model to consider both local information and global information of the sequence. The Another Feed Forward module is similar to the previous Feed Forward module, but is located after the Self-Attention module and the convolution module to further process the representations transformed by these modules. These sub-modules are combined together in a specific order to form Conformer blocks, thereby forming the encoder in the Conformer model.

The first network layer may be an intermediate network layer of the encoder.

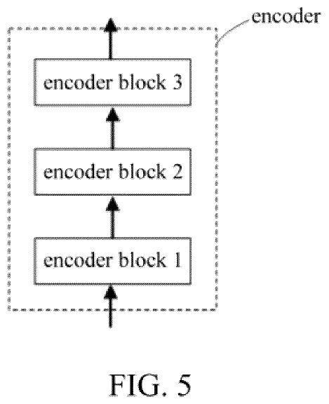

For example, referring to FIG. 5, the encoder shown in FIG. 5 includes a plurality of encoder blocks, such as an encoder block 1 (such as the encoder block in set 1 in FIG. 6), an encoder block 2 (such as the encoder block in set 3 or set 4 in FIG. 6), and an encoder block 3 (such as the encoder block in set 4 in FIG. 6). The input of the encoder block 1 may be the initial input of the encoder, the output of the encoder block 1 may be used as the input of the encoder block 2, the output of the encoder block 2 may be used as the input of the encoder block 3, and the output of the encoder block 3 may be the final output of the encoder. Then, the last layer of the encoder block 1 or the encoder block 2 may be the first network layer, and the last layer of the encoder block 3 may be the second network layer.

The output of the encoder block 1 or the encoder block 2 may be used as the first encoded vector sequence, and the output of the encoder block 3 may be used as the second encoded vector sequence.

The decoding of the first encoded vector sequence by the decoding network to obtain the first decoded vector sequence may include: inputting the first encoded vector sequence into the decoding network, and decoding the first encoded vector sequence by the shared decoder block in the decoding network to obtain the first decoded vector sequence.

In some embodiments, the encoded vector sequence further includes a second encoded vector sequence output by the last network layer in the encoder. Then, the decoding of the encoded vector sequence by the decoding network to obtain the decoded vector sequence may include: decoding the second encoded vector sequence output by the second network layer of the encoder through the decoding network to obtain a second decoded vector sequence.

The encoded vector sequence may include the second encoded vector sequence, i.e. the output of the last network layer of the encoder.

The decoding of the second encoded vector sequence to obtain the second decoded vector sequence may include inputting the second encoded vector sequence into the decoding network, and decoding the second encoded vector sequence by the shared decoder block in the decoding network to obtain the second decoded vector sequence.

In some embodiments, in the speech recognition model, a share decoding network scheme is introduced. Meanwhile, to align with parameters of the prediction decoder network, a shared prediction is constructed. For the interpolation layer position of the encoder for the shared pred decoder, when the layer number of the encoder is twelve, the sixth layer, the eighth layer, and the ninth layer of the encoder may be selected from the twelve layers to perform a parameter experiment to find the interpolation layer position for the shared pred decoder. When the number of layers of the encoder is sixteen, the eighth layer, the twelfth layer, and the fourteenth layer of the encoder may be selected from the sixteen layer to perform the experiments. In doing so, the intermediate network layer of the encoder may be configured to learn more contextual speech information. The training method may further include: calculating a fourth loss based on the decoded vector sequence and the label sequence of the speech sequence sample; and adjusting the network parameter of the encoder based on the fourth loss.

The label sequence corresponding to the speech sequence sample may be a label sequence obtained by performing standard alignment on the speech sequence sample.

The fourth loss may be calculated by using the label smoothing cross-entropy loss function, as follows:

$${ℒ}_{share \_ pred \_ dec} = - {\sum }_{i = 1}^{K} {q}_{i} log {p}_{i} ,$$

where [symbol] _{share_pred_dec} represents the calculated fourth loss, K represents the number of categories, qᵢ represents a posterior probability of the i-th category, and pᵢ represents a label of the i-th category processed by label smoothing to obtain a fourth loss.

Here, qᵢ may be calculated as follows:

$${q}_{i} = \frac{exp ( {z}_{i} )}{{\sum }_{j = 1}^{K} exp ( {z}_{j} )} ,$$

where j∈[1, K], zⱼ represents the posterior probability map of the j-th category and may be calculated with reference to the following calculation formula for zᵢ, and

$${\sum }_{j = 1}^{K} exp ( {z}_{j} )$$

represents the result of summing up all posterior probability mappings from the first category to the K-th category.

Here, zᵢ represents a posterior probability mapping obtained by the shared encoder blocks performing decoding, mapping and the like on an input encoded vector sequence, and may be calculated as follows:

$${Z}_{i} = ω * {y}_{{enc}_{{mid}_{m}}} + bias ,$$

where ω represents the weights of the Linear category layer in the shared encoder blocks, bias represents the offsets of the Linear category layer, and the Linear category layer may map out the predicted probability that each text character belongs to each of the K categories based on the input. For example, if K represents 5,000 words, and the output of the Linear category layer will have 5,000 dimensions, indicating the probability of the text character in respective ones of the 5000 categories. y_{enc_mid}_{ₘ} represents the encoded vector sequence output by the encoder. In an example, the decoded vector sequence is obtained by processing the encoded vector sequence by using the formula of

$$ω * {y}_{{enc}_{{mid}_{m}}} + bias .$$

Here, pᵢ may be calculated as follows:

$${p}_{i} = \{ \begin{matrix}1 - ε , & if i = y \\ ε / ( K - 1 ) , & otherwise\end{matrix} ,$$

where ε represents a relatively small constant, which may be 0.1. K represents the total number of categories of labels, such as 5000 described above; i represents the i-th label category of the K categories of labels; y represents a text character label in the label sequence. if and otherwise represents two conditions for calculating pᵢ: If (if) the i-th category of label matches the text character label in the label sequence, then pᵢ=1-ε; Otherwise (otherwise), pᵢ=ε/(K−1).

Thus, the calculation formula of pᵢ may be used to determine a probability vector of K dimensions for each text character label in the label sequence. The probability vector includes K probabilities pᵢ, and each probability pᵢ indicates a probability value of the text character label belonging to the i-th label category of the K label categories.

The Label smoothing is a regularization method used for classification problems, particularly used in combination with cross-entropy (CE) loss. The main purpose is to prevent the model from predicting the tags too confidently during training, thereby improving the generalization capability of the model.

In particular, Label smoothing transforms a hard label into a soft label, making network optimization smoother. This is realized by replacing the original one-hot-encoded label vector with an updated label vector combining a uniform distribution and a small hyper-parameter a (e.g., 0.1). This is equivalent to adding noise to the real distribution to avoid overconfidence prediction of the model in the correct label, so that the difference between the output values of the predicted positive and negative samples become less, thereby avoiding overfitting and improving the generalization capability of the model.

The step of adjusting the parameters of the model based on the loss may include: using a calculated loss value as a basis for an optimization algorithm to guide the adjusting of parameters of the model.

Further, the parameters of the model are adjusted by using an optimization algorithm, and common optimization algorithms include gradient descent, stochastic gradient descent (SGD), mini-batch gradient descent, and the like. The optimization algorithm may update the parameters of the model according to the gradient of the loss function with respect to the parameters of the model, that is, the derivative of the loss value to the parameters.

For example, in gradient descent, for each iteration, the parameters are updated according to the gradient of the loss function with respect to the parameters so that the loss value gradually decreases.

In each iteration, the optimization algorithm calculates the gradient of the loss function with respect to the parameters of the model and updates the parameters according to the direction and magnitude of the gradient. The updating of parameters is an iterative process, and parameter configurations that minimize loss values are gradually obtained through a plurality of iterations.

Throughout the training process, it is necessary to iteratively optimize the parameters of the model and evaluate the performance of the model on the validation set. If the model achieves satisfactory performance on the validation set, the training may be stopped; Otherwise, it is necessary to continue to adjust the parameters and optimize the model.

When adjusting the parameters of the model, attention must be paid to overfitting and underfitting. Overfitting means that the model performs well on training data but poorly on test data; Underfitting means that the model has poor performance in both training and test data. To avoid overfitting, methods such as regularization techniques, early stop methods, and increasing data diversity may be used. To solve the underfitting problem, methods such as increasing model complexity, using more complex features, and the like may be used.

The adjusting of the network parameter of the encoder based on the fourth loss may include iteratively performing the following operations until the calculated fourth loss is less than a preset loss value: taking the calculated fourth loss as a basis of an optimization algorithm, obtaining a gradient of the network parameter of the encoder based on the fourth loss by the optimization algorithm, and then updating the network parameter of the encoder based on the direction (e.g., descent direction) and the magnitude of the gradient. The adjusting of the network parameter of the encoder is then finished.

In the process of model training, adjusting the network parameters of the model includes: the optimization algorithm, and the like of the model to improve the performance of the model. For example, adjusting the network parameters may include: optimizing algorithms and learning rates, adding regularization, etc.

The selection of the optimization algorithms and the learning rates may include selecting an appropriate optimization algorithm, such as SGD, Adam, RMSprop, and the like. Different optimization algorithms are suitable for different tasks and model architectures. Adjusting the learning rate is needed because a too great learning rate may lead to unstable training, and a too less learning rate may lead to too slow training speed or falling into local optima. Learning rates may be dynamically adjusted by using learning rate scheduling strategies, such as exponential decay, cosine decay, and the like.

The adding of the regularization may include using L1 or L2 regularization to prevent overfitting. A portion of the neurons may be randomly discarded during training by using the Dropout layer to reduce co-adaptation between the neurons. The Batch Normalization layer is used to normalize the input of each layer, which helps speed up training and improves the generalization capability of the model.

In some embodiments, to increase the decoding speed of the speech recognition model and reduce the latency, the encoder may further include a third network layer, the training method may further include: obtaining a third encoded vector sequence output by the third network layer during processing of the speech sequence sample by the encoder, and performing a posterior probability calculation based on the third encoded vector sequence to obtain a posterior probability sequence; determining a mask position corresponding to the attention mechanism in the encoder based on a posterior probability sequence; and encoding processing is performed by the first network layer and the second network layer of the encoder based on the mask position.

The speech sequence may include a plurality of time frames, each time frame may correspond to one speech frame, and the encoded vector sequence extracted by the encoder may include an encoded vector sequence corresponding to each time frame of the speech sequence.

The third network layer may be an intermediate network layer of the encoder (e.g., a last network layer from a set 2 in FIG. 6). Then the third encoded vector sequence output by the third network layer refers to the encoded vector sequence output by an intermediate encoder module (e.g., a set 2 in FIG. 6) of the encoder.

In model training, the input speech signal may be segmented into a series of time frames, and each time frame generates a probability distribution representing the probability of all possible characters (or phonemes) corresponding to the time frame.

In some embodiments, the preset speech recognition model may further include an attention mask module that may be connected to an intermediate encoder module (such as set 3 in FIG. 6) of the encoder and may be configured to guide the selection of the attention mask in the Efficient Conformer.

The attention mask may be configured to direct the attention mechanism to ignore certain portions of the input during the calculation. For example, the attention mask is a matrix of the same shape as the input sequence, where the value in the attention mask determines whether the model should attend to the corresponding input position when calculating the attention weight. Attention mask is a Boolean matrix with the same shape as the input sequence. For each position in the input sequence, if it corresponds to a valid input (i.e., not a padding token), the value of the attention mask at that position is True (or one), otherwise the value of the attention mask at that position is False (or zero). In calculating the attention weights, the model uses this mask to ignore those padding positions.

In an embodiment, some embodiments of the present disclosure refer to a frame-skipping decoding scheme in recurrent neural network transducer (RNN-T), and applies the frame-skipping decoding scheme to the intermediate layer CTC, thereby reducing the number of CTC skips (CTC spikes) and increasing the number of zero-padding portions of attention mask, thereby reducing number of calculations of attention.

Here, the frame-skipping decoding scheme selectively skips certain frames during speech signal processing instead of performing frame-by-frame predictions. to reduce the number of calculations and accelerate the decoding speed, when the speech signal is processed.

Where CTC spike refers to the CTC transient peaks, during prediction of the CTC, the model outputs a probability distribution for each time step in the input sequence, and the probability distribution contains the probabilities of all possible output symbols (including blank symbols). The CTC then compares all possible output sequences (including blank symbols) with the ground-truth output sequences through a dynamic programming algorithm and calculates the score for each output sequence. Finally, the output sequence with the highest score will be used as a prediction result.

In this process, “spike” refers to the positions of those non-blank symbols in the predicted output sequence. Since the CTC does not care whether each result in the prediction output sequence is exactly aligned with the input sequence at a timepoint, these non-blank symbols may cluster at certain time steps, to form the “spike”. These spikes represent the positions where the model is believed to be most likely to produce valid outputs.

The posterior probability sequence may include a posterior probability for each time frame, and the posterior probability includes a probability of all possible output symbols corresponding to an encoded vector at each time frame.

In some embodiments, the attention mask module may include a Linear layer that may accept an input tensor (e.g., the output of the previous layer) and output a new tensor (current output) by multiplying the input tensor by a weight matrix and adding a bias vector.

Further, the predicted value of the linear regression from the Linear layer is mapped to a value between zero and one by the softmax function, and the sum of the probabilities across all categories is one, the value between zero and one represents the probability for each category. Then the output is a vector representing the probability distribution for respective ones of the categories.

In some embodiments, the performing of the posterior probability calculation based on the third encoded vector sequence to obtain the posterior probability sequence may include: performing mapping processing on an encoded vector sequence output from one of the intermediate network layers by the attention mask module to obtain posterior probability information for each time frame.

In an embodiment, the encoded vector sequence for each time frame may be input to the Linear layer and then a linear transformed output is obtained by performing linear transformation on the encoded vector sequence by the Linear layer. Then the linear transformed output is normalized to values between zero and one by the softmax function to obtain a probability of the intermediate encoding at each time frame belonging to respective ones of the categories as a posterior probability for each time frame, thereby obtaining a posterior probability sequence.

In some embodiments, the determining of the mask position corresponding to the attention mechanism in the encoder may include: determining probability spikes in the posterior probability sequence; reducing the number of the probability spikes in the posterior probability sequence to obtain a reduced posterior probability sequence; and determining the mask position corresponding to the attention mechanism in the encoder based on the reduced posterior probability sequence.

Further, the probability spikes may be generated from the posterior probability information, and then, based on the probability spikes, it is determined which time frames are to be masked by the mask. The more masked time frames, the faster the inference speed will be.

The determining of the probability spikes in a posterior probability sequence may include determining the probability spikes based on the position of the non-blank symbols in the posterior probability sequence.

The reducing of the number of the probability spikes in the posterior probability sequence to obtain the reduced posterior probability sequence may include removing the consecutive repeated probability spikes in the posterior probability sequence to obtain the reduced posterior probability sequence.

The determining of the mask position corresponding to the attention mechanism in the encoder based on the reduced posterior probability sequence may include determining positions corresponding to the probability spikes in the reduced posterior probability sequence as the mask position corresponding to the attention mechanism in the encoder.

Based on the attention mask network according to an embodiment of the present disclosure, the spikes that the CTC posterior probability needs to be activated and the positions where the attention needs to be concerned may be better reduced, thereby accelerating the decoding speed. The reducing of the number of repeated spikes is intended to limit the spin jumps of graph nodes, and when the successive repeated alignments occur, a greater penalty will be imposed, and the penalty value being a hyperparameter.

In some embodiments, to accurately identify mask positions using the attention mask module, the training method may further include: calculating a third loss based on the reduced posterior probability sequence and the label sequence; and adjusting the network parameters of the encoder based on the third loss.

In some embodiments, the attention mask network may include a spike loss function that may be used to improve the mask labeling accuracy of the attention mask network.

Here, the spike loss function may calculate a loss, i.e., a third loss, based on the reduced posterior probability sequence and the label sequence.

The calculating of the loss based on the reduced posterior probability sequence and the label sequence may include calculating the third loss based on the spike positions in the reduced posterior probability sequence and the spike positions in the label sequence, and adjusting the network parameters of the encoder based on the third loss iteratively until the difference between the spike values generated according to the reduced posterior probability sequence and the spike values of the label sequence is less than a preset difference, thereby completing the training of the attention mask network.

The adjusting of the network parameters of the encoder based on the third loss may include iteratively performing the following operations until the calculated third loss is less than a preset loss value: taking the calculated third loss as a basis of an optimization algorithm, obtaining a gradient of the network parameters of the encoder based on the third loss by the optimization algorithm, and then updating the network parameters of the encoder based on the direction and the magnitude of the gradient, thereby completing adjustment of the network parameters of the encoder.

At Step 203, vector fusion is performed on the encoded vector sequence and the decoded vector sequence through the decoding network to obtain a fused vector sequence.

In some embodiments, the performing of the vector fusion on the encoded vector sequence and the decoded vector sequence through the decoding network to obtain the fused vector sequence may include: expanding decoded vectors of the decoded vector sequence in quantity to obtain an expanded decoded vector sequence; and in response to determining that the number of decoded vectors in the expanded decoded vector sequence is equal to the number of time frames of the encoded vectors of the encoded vector sequence, performing vector concatenation on the expanded decoded vector sequence and the encoded vector sequence to obtain the fused vector sequence.

In the process of expanding the decoded vectors in the decoded vector sequence in quantity, the expansion of the decoded vectors in quantity may be performed according to the number of time frames of the encoded vectors in the encoded vector sequence.

In some embodiments, in order to minimize the difference between the decoded vector before performing the expansion and the expanded decoded vector, the expanding of the decoded vectors in the decoded vector sequence in quantity through the decoding network to obtain the expanded decoded vector sequence may include: copying the decoded vector (for clarity, it may be called as a first decoded vector) in the decoded vector sequence through the decoding network to obtain a copy vector; and interpolating the duplicated vector into a position in the decoded vector sequence adjacent to the decoded vector (i.e., the first decoded vector) to obtain an expanded decoded vector sequence.

In an embodiment of the present disclosure, the preset speech recognition model may further include a frame repetition module. The frame repetition module may be a frame repetition module. The frame repetition module may be configured to perform adjacent-frame replication on the decoded vector sequence, where the total number of adjacent-frame replication operations may be determined according to the dimension TI of the encoded vector sequence y_{enc}, such that the number of the decoded vectors of the expanded decoded vector sequence is equal to the number of time frames of the encoded vectors of the encoded vector sequence.

Further, the frame repetition module performs copy processing on the decoded vectors in the decoded vector sequence to obtain the copy vectors, and then the copy vectors are interpolated into the position in the decoded vector sequence adjacent to the first decoded vector to obtain the expanded decoded vector sequence.

In some embodiments of the present disclosure, similarly to recovery after frame reduction for the encoder in the Squeezeformer (a deep learning model for speech recognition), the output result of the shared decoder block is repeated at the frame level, so that the resolution in the time dimension may be reduced without losing too much information.

The performing of the vector concatenation based on the expanded decoded vector sequence and the encoded vector sequence to obtain the fused vector sequence may include performing the vector concatenation on the expanded decoded vector sequence and the encoded vector sequence by the connection module to obtain the fused vector sequence.

In an embodiment of the present disclosure, the preset speech recognition model further includes the connection module. The connection module may be a Concatenation layer (i.e., concat layer). The concat layer may be configured to concatenate a plurality of input tensors along a preset axis. Therefore, the width of the network may be increased, i.e., the dimension (rather than the depth) of the vector may be increased (i.e., the number of layers may be increased).

The performing of the vector fusion on the expanded decoded vector sequence and the encoded vector sequence by the connection module to obtain the fused vector sequence may include: performing vector concatenation on the expanded decoded vector sequence and the encoded vector sequence by the concat layer to obtain the fused vector sequence.

For example, the expanded decoded vector sequence may be y_{dec_pred}, and the dimension thereof is B×K×F, where B represents the batch size, K represents the total number of predicted token, and F represents attention dimension (attention dim, the dimension configuration used in constructing the attention model). The encoded vector sequence may be y_{enc}, and the dimension thereof is B×T×F, B represents the batch size, T represents the downsampled time frame, and F represents attention dimension. Since K≤T, dimension adaptation is required when y_{dec_pred} and y_{enc} is fused.

In some embodiments, if the encoded vector sequence includes the first encoded vector sequence and the second encoded vector sequence, the performing of the vector fusion on the encoded vector sequence and the decoded vector sequence through the decoding network to obtain the fused vector sequence may include: performing vector fusion on the first decoded vector sequence and the second encoded vector sequence output by the second network layer of the encoder through the decoding network to obtain the fused vector sequence.

The performing of the vector fusion on the second encoded vector sequence and the first decoded vector sequence through the decoding network to obtain the fused vector sequence may include: expanding the decoded vector in the first decoded vector sequence in quantity through the decoding network to obtain the expanded first decoded vector sequence, and then performing fusion on the expanded first decoded vector sequence and the second encoded vector sequence to obtain the fused vector sequence.

In some embodiments, if the encoded vector sequence includes the second encoded vector sequence, the performing of the vector fusion on the encoded vector sequence and the decoded vector sequence through the decoding network to obtain the fused vector sequence may include: performing the vector fusion the second encoded vector sequence and the second decoded vector sequence through the decoding network to obtain the fused vector sequence.

The performing of the vector fusion on the second encoded vector sequence and the second decoded vector sequence through the decoding network to obtain the fused vector sequence may include: expanding the decoded vector in the second decoded vector sequence in quantity through the decoding network to obtain an expanded second decoded vector sequence, and then performing fusion on the expanded second decoded vector sequence and the second encoded vector sequence to obtain the fused vector sequence.

At Step 204, mapping processing is performed on the fused vector sequence through the decoding network to obtain a mapped vector sequence.

In an embodiment of the present disclosure, the preset speech recognition model may further include a joint network. The joint network may merge or combine a plurality of input streams (which may be from different networks, vector sets or data modalities) at certain points in the network to operate together to perform subsequent calculations or predictions. The joint network structure are configured to process multi-modal data (e.g., images, texts, audio) or multi-source information to take advantage of complementarity characteristics between different inputs.

The performing of the mapping processing on the fused vector sequence through the decoding network to obtain the mapped vector sequence may include performing mapping processing on the fused vector sequence by using the joint network in the decoding network to obtain the mapped vector sequence.

In some embodiments, the merging strategy of the joint network may include:

Concatenation: A plurality of input vectors are concatenated in a specific dimension to form a greater vector or vector graph;
Addition: In some cases, it may be desirable to add input vectors from different sources directly instead of concatenation. This requires the input vectors (or be called inputs) to have the same shape and dimension;
Attention Mechanisms: When processing the multimodal data, the attention mechanism may help the network learn how to assign different weights to different inputs in order to take into account the relative importance of different inputs in fusion;
Product: In some applications, it may be meaningful to multiply input vectors from different sources in an element-wise fashion, and it may be considered as a method of vector selection or weighting;
Custom Fusion Layers: Depending on the specific application and data type, custom fusion layers may be provided, and the custom fusion layers may contain complex calculations or non-linear operations to better fuse information from different sources;
Multimodal Embedding Spaces: When processing multimodal data, a separate embedding space may first be learned for each modality, and then a kind of fusion is performed on these embedding spaces;
Branch-and-Merge Architecture: In this architecture, the network is first divided into a plurality of branches, each of the branches processes one type of input. These branches are then merged at some point for subsequent calculation or prediction.

The performing of the mapping processing on the fused vector sequence by the joint network to obtain the mapped vector sequence corresponding to the fused vector sequence may include: adding a ReLU activation function to introduce a non-linear element after performing linear transformation on the fused vector sequence by the Linear layer of the joint network. Mapping processing is performed by Linear layers and ReLU activation functions to obtain the mapped vector sequence. This combination allows the network to learn complex relationships between input vectors and to improve the representation capability of the network.

In some embodiments, the training method may further include: calculating a second loss based on the difference between the mapped vector sequence and the second encoded vector sequence; and adjusting the network parameters of the encoder based on the second loss.

In some embodiments, to mitigate inconsistencies between training and inference of the speech recognition model, the calculating of the second loss based on differences between the mapped vector sequence and the second encoded vector sequence may include: inputting the second encoded vector sequence and the mapped vector sequence into a distillation module; calculating a distillation loss as a second loss by the distillation module by using the second encoded vector sequence as an output of the student model and the mapped vector sequence as an output of the teacher model.

In an embodiment of the present disclosure, the speech recognition model may further include the distillation module. The distillation module may be configured to perform distillation processing on the outputs of the encoder and the joint network so that the encoder may learn the knowledge of the shared decoder block, such that the encoded vector sequence output by the encoder may be aligned with the output of the shared decoder block of the decoding network during inference.

The distillation module may be provided with a distillation method. For example, the distillation method may include a Frame-level distillation method, a Sequence-level distillation method, and the like.

Here, Frame-level distillation is the distillation technique applied in video processing or time series analysis tasks.

In deep learning, distillation is a Knowledge Transfer technique that allows a model (a teacher model) to transfer its learned knowledge to another model (a student model). The student model is smaller or simpler than the teacher model.

In video processing or time series analysis, the data is presented in the form of a Frame. Therefore, Frame-level distillation is concerned with how to transfer knowledge at Frame-level from the teacher model to the student model. Such distillation is intended to reduce calculation costs, increase inference speed, or reduce memory consumption while maintaining or approximating the performance of the teacher model.

Sequence-level distillation is a knowledge distillation technique applied to sequence data (e.g., texts, speech, etc.). The sequence-level distillation is intended to transfer the knowledge learned by a complex larger model (teacher model) to a simpler and smaller model (student model) while maintaining or approximating the performance of the teacher model. In Sequence-level distillation, the entire sequence data (and not just a single data point) is considered a unit of distillation. This means that during training, both the teacher model and the student model will operate on the entire sequence data and may match the output or behavior at the entire sequence level.

the calculating of the distillation loss as the second loss by the distillation module by using the second encoded vector sequence as the output of the student model and the mapped vector sequence as the output of the teacher mode may include: inputting the second encoded vector sequence as the output of the student model to the distillation module; inputting the mapped vector sequence as the output of the teacher model to the distillation module, and processing the second encoded vector sequence and the mapped vector sequence by the distillation method configured in the distillation module, to calculate the loss; adjusting the network parameters of the encoder iteratively based on the calculated loss, so that the output of the encoder may be aligned with the output of the shared decoder block.

In some embodiments, for the Frame-level distillation method, the loss function corresponding to the Frame-level distillation method may be used to calculate the distillation loss as follows:

$${ctc \_ {KD}_{frame}}_{} = - {\sum }_{x ∈ Z} {\sum }_{t = 1}^{T} {\sum }_{n ∈ K} {p}_{joint} ( n \vert {x}_{t} ) ln {p}_{enc} ( n \vert {x}_{t} ) ,$$

where [symbol] _{ctc_KD}_{_{frame}} represents the distillation loss calculated by the loss function corresponding to the Frame-level distillation method, Xₜ represents the t-th frame sample in the input sequence x (i.e., y_{enc}) with a length of TL, and Z represents the number of samples in the input sequence x (i.e., y_{enc}) with the length of TL. K represents the CTC label set, K=L∪{blank}, where L represents the original label set, n represents the CTC label in the CTC label set. pⱼₒᵢₙₜ represents a posterior probability, adjusted by using the temperature (or be called temperature parameter, parameter temperature, distillation temperature) TP, of the output of joint network CTC, and p_{enc} represents a network estimated posteriori probability, adjusted by using the temperature TP, of the output of encoder.

Here, a posterior probability of Connectionist Temporal Classification (CTC) adjusted by using the temperature TP actually corresponds to “softening” or “smoothing” of the original posterior probability distribution.

In machine learning and deep learning, temperature parameters are a hyperparameter used to control the sharpness degree of the probability distribution. When the temperature parameter TP is relatively less, the probability distribution is sharper, that is, the confidence of the model for a certain prediction result is higher. When the temperature parameter TP is relatively greater, the probability distribution is smoother, that is, the confidence of the model for the plurality of prediction results is relatively uniform.

In some embodiments, for the Sequence-level distillation method, the loss function corresponding to the Sequence-level distillation method may be used to calculate the distillation loss as follows:

$${ctc \_ {KD}_{sequence}}_{} = - {\sum }_{x ∈ Z} {\sum }_{s ∈ S} {p}_{joint} ( s \vert x ) ln {p}_{enc} ( s \vert x ) ,$$

where [symbol] _{ctc_KD}_{_{sequence}} represents the distillation loss calculated by the loss function corresponding to the Sequence-level distillation method; S represents the assumed of all possible label sequences. For convenience of calculation, an embodiment selects 10 best is provided in an embodiment of the present disclosure; s represents a label sequence; x represents an input sequence (i.e., y_{enc}) with a length of TL; Z represents the number of samples of the input sequence x (i.e. y_{enc}). pⱼₒᵢₙₜ and p_{enc} are the posterior probabilities of the hypothetical s estimated by the joint network CTC model and the encoder CTC model, respectively.

The adjusting of the network parameters of the encoder based on the distillation loss may include adjusting the network parameters of the encoder based on the calculated distillation loss until the distillation loss is less than the preset distillation loss. Meanwhile, the output of the encoder may be aligned with the output of the shared decoder block, to ensure the consistency between inference process and training process.

Further, the network parameters of the encoder may be adjusted based on the second loss. Alternatively, the adjusting of the network parameters of the encoder based on the second loss may be described in the description of the above model parameter adjustment step.

At Step 205, a first loss for the speech sequence sample is determined based on the mapped vector sequence and a label sequence of the speech sequence sample.

In some embodiments, the CTC loss for the decoding network may be calculated as the first loss for the speech sequence sample based on the mapped vector sequence.

Here, the CTC loss for the decoding network is calculated by using the CTC loss function (e.g., by CTC loss module in FIG. 6) based on the mapped vector sequence, as follows:

$${ctc \_ pred}_{} = {\sum }_{ε ∈ {δ}^{- 1} ( l )} {log}_{p} ( ε \vert {y}_{joint} ) ,$$

where [symbol] _{ctc_pred} represents the calculated CTC loss, namely, the first loss; l represents a label sequence of a speech sequence sample, l=(l₁ . . . lₙ), the length of the label sequence is n; δ(·) represents a many-to-one mapping for removing blank symbols and repeated outputs during alignment; ε Refers to a mapping in δ(·); yⱼₒᵢₙₜ represents the output result of the joint network, that is, the mapped vector sequence.

At Step 206, the network parameters of the encoder in the speech recognition model are adjusted based on the first loss to complete training of the speech recognition model.

The adjusting of the network parameter of the encoder based on the first loss may include iteratively performing the following operations until the calculated first loss is less than a preset loss value: using the calculated first loss as a basis of an optimization algorithm, obtaining a gradient of the network parameter of the encoder based on the first loss by the optimization algorithm, and then updating the network parameter of the encoder based on the direction and the magnitude of the gradient. Therefore, training of the speech recognition model is completed.

In some embodiments, the second encoded vector sequence output by the last layer in the network layers of the encoder may be decoded by the decoder in the speech recognition model to obtain a third decoded vector sequence, and then a fifth loss is calculated based on the third decoded vector sequence and the label sequence. The network parameters of the encoder and decoder of the speech recognition model are then adjusted based on the fifth loss.

The decoder may further include a first decoder module (left decoder block as shown in FIG. 6) and a second decoder module (right decoder block as shown in FIG. 6), and the third decoded vector sequence output by the decoder may include a first sub-decoded vector sequence output by the first decoder module and a second sub-decoded vector sequence output by the second decoder module. In an embodiment, the output of the left decoder module is different from the output of the right decoder module. The second encoded vector sequence is first input to the left decoder block, the processed result output by the left decoder block is input to the right decoder module, and the output of the right decoder block is used as the final output of the decoder.

The calculating of the fifth loss based on the third decoded vector sequence and the label sequence may include calculating a first decoding sub-loss based on the first sub-decoded vector sequence and the label sequence, and calculating a second decoding sub-loss based on the second sub-decoded vector sequence, and then obtaining the fifth loss based on the first decoding sub-loss and the second decoding sub-loss.

The first decoding sub-loss may be calculated by using the label smoothing cross entropy loss function, and may be calculated from the first sub-decoded vector sequence and the label sequence as follows:

$${ℒ}_{l \_ dec} = - {\sum }_{i = 1}^{K} {q}_{i \_ dec \_ left} log {p}_{i} ,$$

where [symbol] _{t_dec} represents the calculated first decoding sub-loss; K represents the number of categories, q_{i_dec_left} represents a posterior probability of the i-th category in the first decoder module, and Pᵢ represents a label of the i-th category, and label smoothing is performed on the label to obtain the first decoding sub-loss.

The second decoding sub-loss may be calculated by using the label smoothing cross entropy loss function, and may be calculated based on the second sub-result as follows:

$${ℒ}_{r \_ dec} = - {\sum }_{i = 1}^{K} {q}_{i \_ dec \_ right} log {p}_{i} ,$$

where [symbol] _{r_dec} represents the calculated second decoding sub-loss; K represents the number of categories, q_{i_dec_right} represents a posterior probability of the i-th category in the second decoder module, and Pᵢ represents a label of the i-th category, and label smoothing is performed on the label to obtain the second decoding sub-loss.

Further, the second decoding loss is obtained based on the first decoding sub-loss and the second decoding sub-loss as follows:

$${ℒ}_{dec} = μ * {ℒ}_{l \_ dec} + ( 1 - μ ) * {ℒ}_{r \_ dec} ,$$

where [symbol] _{dec} represents the calculated fifth loss; and μ represents a weight value, and μ is less than one.

In some embodiments, to further improve the consistency between the inference process and the training process, the training process of the encoder may be divided into two phases, i.e., a first phase and a second phase. The second phase follows the first stage. The first phase ends under the condition that the adjustment of the encoder based on the first encoding loss and the second encoding loss satisfies a preset condition.

For example, the first phase may end under the condition that both the first loss and the fourth loss are less than the preset loss, which indicates that the relatively optimized adjustment of the encoder by the first loss and the fourth loss is realized.

The training of the encoder by the distillation module may be carried out at the second phase. That is, the parameters of the encoder are first adjusted according to the first loss and the fourth loss, and in response that the preset condition is satisfied, the distillation module may start to train the encoder.

In some embodiments, to improve the training effect of the speech recognition model, the training method may further include:
calculating an encoding loss based on the second encoded vector sequence and the label sequence corresponding to the speech sequence sample;
calculating a first total loss at least based on the first loss, the third loss, the fourth loss, the fifth loss, and the encoding loss;
calculating a second total loss based on the first total loss and the second loss;
adjusting a network parameter of the encoder based on the first total loss at a first phase; and
adjusting the network parameter of the encoder based on the second total loss at the second phase.

The label sequence may include a label sequence corresponding to the speech sequence sample. The encoding loss may include the loss for the encoder.

Here, the encoding loss may be calculated by using the CTC loss function, as follows:

$${ℒ}_{ctc \_ enc} = {\sum }_{ℰ ∈ {δ}^{- 1} ( l )} {log}_{p} ( ε \vert {y}_{enc} ) ,$$

where [symbol] _{ctc_enc} represents the calculated encoding loss; l represents a label sequence, l=(l₁ . . . lₙ), the length of the label sequence is n; δ(·) represents a many-to-one mapping for removing blank symbols and repeated outputs generated during alignment; ε Refers to a mapping in δ(·); y_{enc} represents the output of the last network layer of the decoder, that is, the mapped vector sequence, that is, the second encoded vector sequence.

The first total loss refers to the total loss at the first phase, and may be calculated as follows:

$${ℒ}_{f\_total} = α * ( β * {ℒ}_{ctc \_ enc} + γ * {ℒ}_{ctc \_ middle} + ( 1 - β - γ ) * {ℒ}_{ctc \_ pred} ) + ( 1 - α ) * ( λ * {ℒ}_{share \_ pred \_ dec} + ( 1 - λ ) * {ℒ}_{dec}$$

where [symbol] _{f_total} represents the calculated first total loss; [symbol] _{ctc_enc} represents the encoding loss; [symbol] _{ctc_middle} represents the loss for the attention mask module (i.e., the third loss); [symbol] _{ctc_pred} represents the first loss of the decoding network; [symbol] _{share_pred_dec} represents a fourth loss for the decoding network; [symbol] _{dec} represents the fifth loss; and α, β, γ, and λ represent respective weight values, and α, β, γ, λ∈ (0,1).

The second total loss may be calculated based on the first total loss and the distillation loss (i.e., the second loss), as follows:

$${ℒ}_{total} = φ * {ℒ}_{f \_ total} + ( 1 - φ ) * {ℒ}_{KD} ,$$

where [symbol] ₜₒₜₐₗ represents the second total loss, [symbol] _{KD} represents the distillation loss that may be [symbol] _{ctc_KD}_{_{frame}} or [symbol] _{ctc_KD}_{_{sequence}}, and φ represents a weight value and φ∈ (0, 1).

The adjusting of the network parameters of the encoder based on the first total loss at the first phase may include adjusting each network parameter of the speech recognition model until the first total loss is not greater than the first preset loss in response that the first total loss value is greater than the first preset loss.

Alternatively, at the first phase, the adjusting of adjusting the network parameter of the encoder based on the first total loss at the first phase may include adjusting the network parameter of the encoder based on the first loss and at least one of the third loss, the fourth loss, the fifth loss, and the encoding loss.

For example, the network parameter of the encoder may be adjusted based on the first loss and the third loss; For another example, the network parameter of the encoder may be adjusted based on the first loss, the third loss, and the fourth loss; For another example, the network parameter of the encoder may be adjusted based on the first loss, the third loss, the fourth loss, and the fifth loss; For yet another example, the network parameter of the encoder may be adjusted based on the first loss, the third loss, the fourth loss, the fifth loss, and the encoding loss.

The adjusting of the network parameter of the encoder based on the second total loss at the second phase may include: in response that the second total loss value is greater than the second preset loss, adjusting the parameters of the encoder until the second total loss is not greater than the second preset loss. Thus, training of the speech recognition model may be completed to obtain the trained speech recognition model, and the trained speech recognition model may be applied to various speech recognition scenes.

Alternatively, in the present embodiment, at the second phase, the second loss may be further calculated on the basis of the first total loss calculated at the first phase. The adjusting of the network parameter of the encoder based on the second total loss at the second stage may include: adjusting the network parameter of the encoder based on the second loss, and at least one of the first loss, the third loss, the fourth loss, the fifth loss, and the encoding loss to complete the training of the speech recognition model.

For example, the network parameter of the encoder may be adjusted based on the first loss, the second loss, and the third loss. For another example, the network parameter of the encoder may be adjusted based on the first loss, the second loss, the third loss, and the fourth loss. For another example, the network parameter of the encoder may be adjusted based on the first loss, the second loss, the third loss, the fourth loss, and the fifth loss; For another example, the network parameter of the encoder may be adjusted based on the first loss, the second loss, the third loss, the fourth loss, the fifth loss, and the encoding loss.

In an embodiment of the present disclosure, the decoding network may be removed from the speech recognition model after the model training is completed. That is, the trained speech recognition model includes the encoder, the decoder, and the attention mask module.

An embodiment of the present disclosure discloses a training method of a speech recognition model, including: obtaining an encoded vector sequence output by an encoder of the speech recognition model after a speech sequence sample is processed through the encoder; decoding the encoded vector sequence through a decoding network to obtain a decoded vector sequence; performing vector fusion on the encoded vector sequence and the decoded vector sequence through the decoding network to obtain a fused vector sequence; performing mapping processing on the fused vector sequence through the decoding network to obtain a mapped vector sequence; determining a first loss for the speech sequence sample based on the mapped vector sequence and the label sequence of the speech sequence sample; and adjusting the network parameters of the encoder in the speech recognition model based on the first loss to complete training of the speech recognition model. The output of the intermediate encoder layer of the encoder is processed through the added decoding network to obtain an intermediate encoded result, and the network parameter of the encoder is adjusted based on the output of the encoder combined with the output of the decoding network, so that the adjusted output of the encoder may be aligned with the output of the decoding network and the output of the encoder, thereby improving the context information capability of the encoder, and improving the end-to-end speech recognition capability of the speech recognition model.

In an embodiment, a speech recognition model may be preset, which is a speech recognition model to be trained, and speech recognition model to be trained may include the encoder, the decoder, the decoding network (including a shared decoder block herein), the attention mask module, and the like.

For example, the preset speech recognition model as shown in FIG. 6 includes a data augmentation module, a convolutional downsampling module, a linear & regularization module, an encoder, an attention mask module, a decoding network, a decoder, and the like.

The data augmentation module may be configured to enlarge the training corpus making the corpus as diverse as possible, so that the trained model has stronger generalization capability.

The convolution downsampling module is configured to perform convolution downsampling and includes a combination of a convolution layer and a pooling layer (also be called a downsampling layer) in a convolution neural network. The convolution downsampling module having the above architecture plays an important role in model training and mainly used to extract key vectors in speech signals and reduce the dimension of data.

The linear & regularization module may be configured to perform linear processing and regularization processing on the input data. The linear processing refers to a processing method in data or signal processing where the system's response to the input signal maintains a linear relationship with the input signal. The regularization processing involves adding a regularization term to the loss function to penalize the complexity of the parameters of the model, thereby controlling the model's complexity and improving the generalization capability of the model.

Here, 10 ms, 40 ms, and 80 ms are different downsampling frequencies, respectively.

The encoder includes four sets, i.e., set 1, a set 2, a set 3, and a set 4 (or be called stage 1, stage 2, stage 3, and a stage 4). Each set includes an encoded block, i.e., conformer block (or be called encoder blocks, Conformer Block network modules of the encoder). In some embodiments, the encoder may employ encoder in Efficient Conformer. The staging of the encoder is determined by the total number of the layers of the encoder. That is, when the encoder has twelve layers in total, each stage includes three layers, and when the encoder has sixteen layers in total, each stage includes three layers. The input of the encoder may be a preprocessed speech sequence, and the outputs of the set 1, the set 2, the set 3, and the set 4 of the encoder are different from each other, and the output of each of the set 1, the set 2, and the set 3 is the intermediate encoded vector of the encoder output, and the output of the set 4 is the final encoded output of the encoder. The layer in the set 1, the set 2, the set 3, and the set 4 of the encoder are intermediate encoder layer (or intermediate network layer).

The attention mask module may include a linear activation module, an attention mask, and a third loss module. The linear activation module may be configured to process the intermediate encoded vector according to the linear activation function to perform mask labeling, and the third loss module may be configured to calculate a loss function of the attention mask module.

The decoding network may include a shared decoder block, a frame repetition module, a connection module, a joint network, a first loss module, a fourth loss module, and a distillation module.

The shared decoder block is the shared pred decoder according to an embodiment of the present disclosure, and the fourth loss module may be configured to calculate the CE loss (that is, the fourth loss) for the shared decoder block based on the decoded result output by the shared decoder block. The frame repetition module may be configured to perform frame repetition processing on the decoded result output by the shared decoder block. The connection module (or concat layer) is configured to perform fusion processing on the second encoded vector sequence output by the last network layer in the encoder and the decoded result output by the shared decoder block to obtain the fused vector sequence. The joint network may be configured to implement the mapping of the fused vector sequence by using the Linear layer and the ReLU activation. The first loss module may be configured to calculate the CTC loss (i.e., the first loss) corresponding to the decoding network based on the output of the encoder and the output of the joint network.

The distillation module may perform distillation processing on the second encoded vector sequence output by the last network layer in the encoder and the output of the joint network by using the distillation method to calculate a distillation loss, i.e., a second loss. The parameters of the decoder are adjusted based on the distillation loss to ensure the consistency between inference process and training process.

The first loss module may calculate the CTC loss corresponding to the encoder based on the output (that is, the encoded vector) of the encoder. The fifth loss module may calculate CE loss corresponding to the decoder based on the output (that is, the output sequence) of the decoder.

In an embodiment of the present disclosure, an intermediate CTC (i.e., linear activation module, the third loss module) is connected to the stage 2 of the encoder and a CTC spike reduction method is utilized to guide the generation of an interlayer attention mask based on a reduced number of spikes. Following the stage 3, the shared prediction decoder (that is, shared decoder block) is connected, and its output is combined with the output from the stage 4, resembling the fusion of the prediction network and the encoder in RNN-T. Additionally, the distillation method is used to minimize the gap between the encoder and joint network.

Here, the base architecture of the encoder employs the Efficient Conformer. On this basis, a new streaming decoding concept for a streaming Efficient Conformer is provided in which the downsampling layer uses four-fold convolution downsampling. Here, for the encoder with the twelve layers, double downsampling is performed on a third layer of the twelve layers by using a stride convolution (stride conv) module, and group attention is applied to the first to third layers (the group size thereof is adjusted to 2). In this way, an eight-fold downsampling is performed on the third layer of the encoder, reducing the frame rate of the input sequence from 80 ms to 10 ms. For sixteen layers of encoder, double downsampling was performed on a fourth layer of the sixteen layers, and group attention was applied to the first to fourth layers (the group size thereof is adjusted to 2).

Here, Group attention, also be called Cascaded Group Attention (CGA), is an attention mechanism whose core idea is to enhance the diversity of vectors input into attention heads. Unlike previous self-attention mechanisms, CGA provides different input partitions for each attention head and cascades output vectors across the attention heads. In particular, the CGA divides the input vector into different segments, with each segment being input to the attention head. Each attention head calculates a self-attention map thereof. Subsequently, the outputs of all attention heads are cascaded and the dimension of the cascaded result is projected back to the dimension of the input through a linear layer. Furthermore, by means of series connection, the output of each attention head is added to the input of the next attention head, thereby gradually refining the vector representation.

In an embodiment of the present disclosure, the basic speech recognition model may be trained by using the training data for the 50,000-hour model in the dataset, and the training only employs the Conformer-Transformer model, where the encoder may employs the Conformer model and the decoder employs the Transformer model. An acoustic vector output by the Conformer model may be mapped to high-level semantic information through the Linear layer of CTC loss. The text information outputted from the decoder may be converted to a semantic vector after performing prediction mapping, and may be the output with a high-level semantic information after being mapped through the Linear layer of the softmax. Then, the semantic information outputted from the conformer and the semantic information output from the transformer are weighted fused to obtain the predicted text information. As a result, a prediction result of a certain time is obtained, and the prediction result of the time, the encoder part, is input to the CTC loss, the decoder part, is input to the attention loss, and the loss summation calculation is performed for multiple rounds of iterations, the training is complete when the loss converges, and the model is saved after training. In order to adapt to different application scenarios, an embodiment proposes three model architectures, which can be divided into three architectures, as shown in Table 1 below.

TABLE 1

| | Num | | |
|---|---|---|---|
| Scale | layers | Attention-embed-dims | FFN-dims |
| S | 12 | 256 | 2048 |
| M | 12 | 384 | 2048 |
| L | 16 | 512 | 2048 |

In Table 1, Scale represents the size of the module, Num layers represents the number of neural network layers in the encoder, and Attention-embed-dims represents the size of the dimension of embedding in the Attention Mechanism. The length of the vector output by the Embedding layer is determined by the size of the dimension and the size of the dimension may affects the subsequent attention layer and other networks. FFN-dims represents the internal dimension size of a Feed-Forward Network (FFN or FF).

In some embodiments, the training of the model may be divided into two phases. At a first phase, the encoder, the pred decoder, and decoder are trained. At the second phase, the distillation training at frame-level and the distillation training of sequence-level are performed.

Here, During warm up, the maximum learning rate is set to 0.001, the batchsize (batch size) is set to 24, and eight graphics processing Units (GPUs) are utilized. In the AiShell corpus, 300 epochs were trained, and finally the averaging model with the top thirty best-performing epochs loss in the dev dataset was taken. In the Librispeech dataset, 100 epochs were trained and finally the averaging model with the top twenty best-performing epochs loss in the dev dataset was taken.

At a second phase, the distillation training is performed, and by distillation, the output of encoder may be better aligned with the output of joint network, ensuring consistency between training and inference. The frame-level distillation was performed first, followed by sequence-level distillation for finetune. At the distillation finetune stage (i.e., sequence-level distillation), the maximum learning rate of the warm up was capped at 0.0001.

In some embodiments, the training results for the AiShell-1 data may be found in Table 2 as follows.

TABLE 2

| | GFLO | | |
|---|---|---|---|
| Model | Ps | Dev | Test |
| Conformer | — | — | 4.61 |
| EBranchformer | 189.3 | 4.2 | 4.5 |
| Branchformer | 238.3 | 4.19 | 4.43 |
| GIC | — | 4.0 | 4.4 |
| Zipformer-S | 40.8 | 4.4 | 4.67 |
| Zipformer-M | 62.9 | 4.13 | 4.4 |
| Zipformer-L | 107.7 | 4.03 | 4.28 |
| SEQ-former-S | 25.02 | 4.34/4.05/4.36 | 4.57/4.23/4.54 |
| SEQ-former-M | 47.06 | 4.24/3.95/4.21 | 4.47/4.18/4.43 |
| SEQ-former-L | 84.14 | 4.07/3.82/4.03 | 4.35/4.07/4.28 |

Table 2 shows a comparison between the trained speech recognition model according to some embodiments and a speech recognition model in the related art including a CTC-AED model, a CTC model, and a transducer model. It can be seen from Table 2 that the trained speech recognition model according to some embodiments performs the best on the Aishell. The trained speech recognition model according to some embodiments has a character error rate (CER) of 3.82% on the dev data and a CER of 4.07% on the test data. Compared to the latest Zipformer model, the trained speech recognition model according to some embodiments is relatively optimized to 4.91% and achieves a lower Gflops (Giga Floating-point Operations Per Second, i.e., one billion floating-point operations per second).

The warm up is a common training strategy, especially in training large neural networks. The core idea of the warm up is to use a less learning rate at an early stage of training, then gradually increase the learning rate up to a preset greater value, and then gradually decrease the learning rate as the training progresses. This process is similar to the change in speed during running, with the speed slowly increasing, then maintaining a certain speed, and finally gradually decreasing.

The epoch refers to a process in which the entire dataset is completely traversed to train the model once. The dev dataset refers to a development set or a validation set. Finetune refers to making small adjustments to a model that has been trained to adapt to new tasks or datasets.

Here, in the speech recognition model shown in FIG. 6, portions labeled “training” may be the portions used in the training process, but are omitted in the actual inference process.

In addition, when decoding with CTC prefix beam search alone, the model of the present scheme may still reach a CER of 4.47% on the test data. For the SEQ-former-S model, the CER on the test set reaches 4.23%, which is relatively reduced by about 8.84% compared to the conformer u2++ and by about 9.42% compared to Zipformer-S with similar Gflops.

By randomly selecting 100 pieces of audio on the test dataset of AiShell, the audio respectively pass through 6 layers of Pred decoder Network, output a vector of each block, and calculate the cosine similarity of each frame and its adjacent frame, respectively.

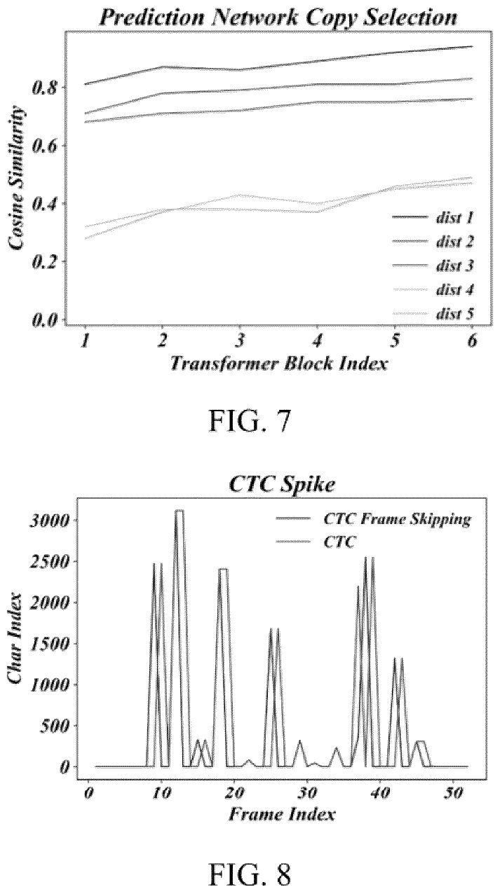

For example, referring to FIG. 7, FIG. 7 shows the frame similarity relationship of Pred decoder. As the number of layers of Pred decoder increases, the similarity between frames becomes very high. The similarity between adjacent frames is 90% or more, the similarity between three adjacent frames is 75% or more, and the similarity between four adjacent frames is 50%, which means that a jump between words occurs.

Therefore, when the frame-level merging is finally performed, the maximum copy length of the adjacent frame is limited to within three frames. If the length still cannot be fused with the output of the encoder, the original fourth frame is directly copy-combined, and if the total length cannot be matched, the copied edge frame is used again to continue copying. The scheme attempts to use the replication of various frame number lengths, and experiments are performed, and it can be seen that when the maximum value of the defined replication length is limited to three frames, the effect is best. When the maximum value of the copy length is limited to four frames, the effect suddenly decreases, which proves the accuracy of the above analysis conclusion.

For example, referring to FIG. 8, FIG. 8 shows peak signal variations before and after the use of CTC spike Reduce. A significant reduction in repetition spikes is clearly illustrated, which helps reduce the computational burden of the intermediate attention layer and increases the inference speed of the encoder. In addition, when CTC spike Reduce is used, the transition to an early peak has a positive effect on the overall delay. In some embodiments, the results on the LibriSpeech data can be found in Table 3 below.

TABLE 3

| | | Test_{—} | Test_{—} |
|---|---|---|---|
| model | GFLOPs | clean | other |
| Squeezeformer-S | 33.7 | 3.08 | 7.47 |
| Squeezeformer-M | 88.4 | 2.56 | 6.50 |
| Squeezeformer-L | 333.7 | 2.47 | 5.97 |
| Conformer WeNet | — | 2.29 | 5.13 |
| EBranchformer-L | 284.4 | 2.14 | 4.55 |
| Branchformer | 238.3 | 2.4 | 5.5 |
| Zipformer-S | 40.8 | 2.42 | 5.73 |
| Zipformer-M | 62.9 | 2.21 | 4.79 |
| Zipformer-L | 107.7 | 2.00 | 4.38 |
| SEQ-former-S | 29.02 | 2.38 | 5.46 |
| SEQ-former-M | 51.12 | 2.29 | 4.95 |
| SEQ-former-L | 88.22 | 2.07 | 4.41 |

Table 3 shows the experimental results on LibriSpeech. It can be seen that the SEQ-former of the present disclosure exceeds the effect of the flow conformer in wenet at a lower Gflops, and also exceeds the effects of Squeezeformer and E-Branchformer-L, in particular, the SEQ-former-S achieves a relative reduction by ⅓ of the parameters compared to conformer in wenet, and the SEQ-former-L achieves a relative reduction in CER by approximately equal parameters. SEQ-former-L achieves a relative decrease in CER at ¼ of Gflops compared to Squeezeformer-L, and a significant decrease in CER compared to other configurations of Squeezeformer. In comparison with E-Branchformer-L, SEQ-former-L achieves a relative reduction in CER at ⅓ of Gflops, and a similar optimization effect is achieved in other configurations. In contrast to Zipformer-S, Zipformer-M, and Zipformer-L, the present solution achieves similar performance to that of Zipformer-S, Zipformer-M, and Zipformer-L, although no exceeding effect is achieved.

In some embodiments, a traversal experiment is performed on the parameters to be adjusted, and the following experiments are performed on the AiShell data, showing the effect on the AiShell test data.

TABLE 4

| | CER |
|---|---|
| T | (%) |
| 1.0 | 4.52 |
| 1.5 | 4.47 |
| 2.0 | 4.43 |
| 2.5 | 4.53 |
| 3.0 | 4.56 |

Table 4 above shows the experimental results for the selection of the distillation temperature TP for the present scheme. The experimental results demonstrate that when the distillation temperature TP is greater than two, the effect begins to deteriorate so the distillation temperature TP is selected as two.

For example, Table 5 below shows the number of layers selection experiments performed with shared pred decoder network. It can be seen that when 16 layers of encoder are used in the present solution, the interpolation layer position at which the shared pred decoder is inserted is better at layer 12, and when the total number of layers of encoder is 12, the position selection of shared decoder is best at layer 9. This is in accordance with the present embodiment. In addition, an embodiment also attempts to use the parameters of the decoder, as shared decoder network, it can be seen that if shared decoder is used directly, the performance will be inferior to the result of using shared pred decoder network.

TABLE 5

| | | Sha. | |
|---|---|---|---|
| | Enc. | Dec. | CER |
| | Num. | Num. | (%) |
| Pred Dec. | 12 | 6 | 4.33 |
| Pred Dec. | 12 | 8 | 4.31 |
| Pred Dec. | 12 | 9 | 4.28 |
| Pred Dec. | 16 | 8 | 4.15 |
| Pred Dec. | 16 | 12 | 4.13 |
| Pred Dec. | 16 | 14 | 4.17 |
| Dec. | 12 | 9 | 4.35 |
| Dec. | 16 | 12 | 4.21 |

For example, Table 6 below shows the hyper-parameter adjustment of the attention mask window in Middle CTC Attention Mask, and it can be seen that an optimal effect is obtained when the window parameter is set to 3.

TABLE 6

| Lef. | Rig. | CER |
|---|---|---|
| Chu. n | Chu. m | (%) |
| 1 | 1 | 4.37 |
| 2 | 2 | 4.29 |
| 3 | 3 | 4.22 |
| 4 | 4 | 4.24 |
| 5 | 5 | 4.28 |

For example, Table 7 below shows a parametric experiment for the penalty weights in CTC spike Reduce, and it can be seen that the best effect can be obtained when the weight is reset to 0.05.

TABLE 7

| Penalty | CER |
|---|---|
| Weight | (%) |
| 0.02 | 4.36 |
| 0.03 | 4.29 |
| 0.04 | 4.26 |
| 0.05 | 4.23 |
| 0.06 | 4.31 |

In the above formulas, α, β, γ, and λ are equal to 0.5, 0.7, 0.1, and 0.2, respectively. The value of μ is 0.3, and the value of φ is 0.1.

In some embodiments, ablation experiments may be performed, the results of which are shown in Table 8 below.

TABLE 8

| | Homonym | | | |
|---|---|---|---|---|
| | Error | | | |
| | Ratio_{—} | CER_{—} | CER_{—} | |
| | ctc | ctc | att | |
| Model | (%) | (%) | (%) | RTF |
| Conformer in WeNet | 51.37 | 5.16 | 4.63 | 0.105 |
| Effi. Conformer in WeNet | 50.42 | 5.09 | 4.67 | 0.077 |
| + Pred decoder | 48.37 | 4.93 | 4.58 | 0.076 |
| + Frame-Level KD | 48.12 | 4.91 | 4.51 | 0.076 |
| + Sequence-Level KD | 46.29 | 4.83 | 4.48 | 0.077 |
| + Shared pred decoder | 44.90 | 4.61 | 4.28 | 0.077 |
| + Middle CTC Attention Mask | 44.95 | 4.58 | 4.22 | 0.072 |
| + CTC spike Reduce | 44.99 | 4.58 | 4.23 | 0.068 |

Table 8 shows the ablation experiments for SEQ-former, where the RTF test was performed on a Inter® Xeon® Gold 622R CPU @2.90 GHz machine. The first column shows the proportion of homophone errors, in particular, the semantic modeling capability of the encoder is represented by predicting the Pinyin by chat-GLM, using the decoded result and the tag, and calculate the number of words whose Pinyin is same but the prediction result is incorrect. It can be seen that when Pred decoder Network is added, the homonym error ratio decreases from 50.42% to 48.37% and the CER decreases from 4.67 to 4.58. When Frame-Level KD and Sequence-Level KD are used, the homonym error ratio is reduced to 46.29%, and the CER is reduced from 4.58 to 4.48, which proves the effect of improving the semantic understanding ability of encoder. In addition, when Shared pred decoder is added, the homonym error rate decreases to 44.49%, and the CER decreases to 4.28. All of the above schemes have no effect on the RTF since all optimization techniques are added only at the time of training. When Middle CTC Attention Mask is added, although the homonym error ratio is increased slightly from 44.90 to 44.95, the CER is decreased to 4.22 and the RTF is decreased from 0.077 to 0.072. In addition, although the CER is increased from 4.22 to 4.23 after the addition of CTC spike Reduce, the RTF is decreased from 0.072 to 0.068. FIG. 4 shows the peak variation before and after the addition of CTC spike Reduce, and the number of repeated peaks is significantly reduced, thereby reducing the calculation of the intermediate attention layer and accelerating the inference speed of the encoder.

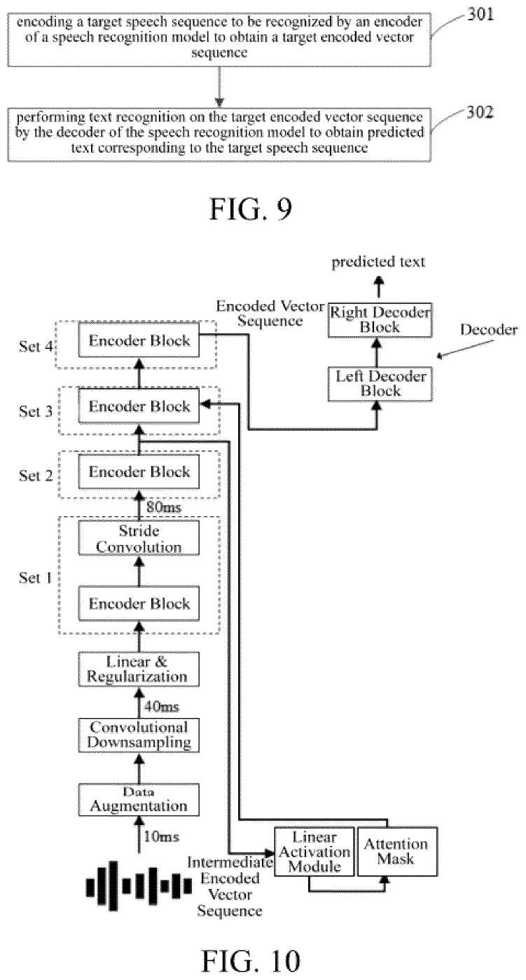

Referring to FIG. 9, FIG. 9 is a schematic flowchart of a speech recognition method according to some embodiments of the present disclosure. The speech recognition method may include Step 301 to Step 302.

At Step 301, a target speech sequence to be recognized is encoded by an encoder of a speech recognition model to obtain a target encoded vector sequence.

The speech recognition model is trained by the training method the speech recognition model according to any of the above embodiments.

The target speech sequence refers to a speech sequence in which speech recognition is required.

For example, in an intelligent conversation system, the target speech sequence may be a user's speech audio, or the like, coming from the user side.

In some embodiments, the encoding oof the target speech sequence to be recognized by the encoder of a speech recognition model may include:
inputting the target speech sequence to be identified into the encoder for encoding processing; obtaining an intermediate encoded vector sequence obtained during the encoding processing of the encoder, and performing a posterior probability calculation to obtain a posterior probability sequence; determining a mask position corresponding to an attention mechanism in the encoder based on the posterior probability sequence; and continuing the encoding processing by the encoder based on the mask position and the intermediate encoded vector sequence to obtain a target encoded vector sequence output by the encoder.

The obtaining of the intermediate encoded vector sequence obtained during the encoding processing of the encoder, and the performing of the posterior probability calculation to obtain a posterior probability sequence may include: obtaining an encoded vector sequence output from an intermediate network layer of the encoder as the intermediate encoded vector sequence during encoding processing on the target speech sequence by the encoder; and obtaining a posterior probability sequence by performing a posterior probability calculation on the intermediate encoded vector sequence through the Linear layer.

Further, the determining of the mask position corresponding to the attention mechanism in the encoder based on the posterior probability sequence may include: performing mask processing on the intermediate encoded vector sequence according to a posteriori probability sequence to obtain a processed intermediate encoded vector sequence. Performing mask processing on the intermediate encoded vector sequence by the attention mask module may include: performing mask labeling on a time frame corresponding to the intermediate encoded vector sequence to masking on a time frame that does not participate in subsequent processing (e.g., by the linear activation module), so as to obtain a processed intermediate encoded vector sequence. This step may reduce the number of inference frames to improve a subsequent inference speed.

Then, the network layer located after the current intermediate network layer in the encoder continues the encoding process based on the mask position and the intermediate encoded vector sequence to obtain the target encoded vector sequence output by the encoder.

In the present embodiment, the determining of the mask position corresponding to the attention mechanism in the encoder based on the posterior probability sequence may include: determining probability spikes in the posterior probability sequence; reducing a number of the probability spikes in the posterior probability sequence to obtain a reduced posterior probability sequence; and determining the mask position corresponding to the attention mechanism in the encoder based on the reduced posterior probability sequence. For the operation of reducing the probability spike, reference may be made to the related description of any of the foregoing embodiments, and details are not described herein.

At Step 302, text recognition is performed on the target encoded vector sequence by the decoder of the speech recognition model to obtain predicted text corresponding to the target speech sequence.

The target encoded vector sequence refers to the final output of the encoder.

Further, the target encoded vector sequence may be input to the decoder in the speech recognition model, and the target encoded vector sequence is decoded by the decoder to obtain the text information corresponding to an audio to be recognized. The text information is an inferred predicted text corresponding to the audio to be recognized.

For example, referring to FIG. 10 where the trained speech recognition model is shown. The trained speech recognition model for inference includes the data augmentation module, the convolutional downsampling module, the linear & regularization module, the encoder, the attention mask module, a decoder, and the like.

That is, in an embodiment of the present disclosure, in the decoding phase, the decoding network shown in FIG. 6 is removed, and only the encoder and the decoder are used to apply CTC prefix beam search and attention rescore. Prefix Beam Search is one of the CTC decoding algorithms for finding the most likely label sequence from the output of the CTC network. Attention rescore refers to re-scoring a plurality of candidate output sequences (e.g., a N-best list) generated by the decoder to find the optimal output. This re-scoring process may be calculated based on the attention mechanism, but may also be based on other models or vectors.

In some embodiments, the trained speech recognition model according to an embodiment may be placed in an intelligent callout scenario. By using the foregoing speech recognition method, a character may be quickly and effectively recognized, thus meeting the translation efficiency and accuracy requirements of the intelligent outbound calling system, and effectively reducing the utilization of the resource by the speech recognition model and solving the problem that the real-time requirement cannot be met. The problem that the real-time requirement cannot be met may cause the next speech stream to have been sent to the system before the decoding on the current speech stream is completed, resulting in thread conflict and bug. When the text is recognized, the recognized text may be sent to the intention understanding module and the speech synthesis module to complete the intelligent outbound calling process of each round.

An embodiment of the present disclosure provides a speech recognition method, including: encoding a target speech sequence to be recognized by an encoder of a speech recognition model to obtain a target encoded vector sequence; and performing text recognition on the target encoded vector sequence by the decoder of the speech recognition model to obtain predicted text corresponding to the target speech sequence. The speech recognition model is trained by the method of training the speech recognition model according to an embodiment of the present disclosure. During the training process, the encoder continuously learns the knowledge of the decoding network. Therefore, after the speech recognition model has been trained, the context understanding ability of the encoder for the speech sequence is significantly enhanced. Therefore, in the speech recognition process, the vector sequence input to the decoder may contain more context information, so that the decoder may perform text recognition more accurately, thereby improving the accuracy of the speech recognition result.

Further, the speech recognition model performs mask processing based on a posterior probability sequence in the encoding process, thereby reducing the number of the inference data for the encoder, improving the inference speed of the encoder, and facilitating the improvement of the end-to-end speech recognition speed.

It is to be understood that although steps in the flowcharts in the above embodiments are shown sequentially as indicated by arrows, these steps are not necessarily performed sequentially as indicated by arrows. Unless expressly stated herein, these steps are not performed in a strict order and may be performed in other orders. Moreover, at least a portion of the steps in the flowcharts in the above embodiments may include a plurality of steps or phases, which are not necessarily performed at the same time, but may be performed at different times, and the execution order of the steps or phases is not necessarily performed in sequence, but may be performed alternately or alternately with at least a portion of the steps or phases in other steps or other steps.

Based on the same inventive concept, an embodiment of the present disclosure further provides an apparatus for training implementing the training method or the speech recognition model. The solution provided by the training apparatus is similar to the solution described in the above training method. Therefore, specific descriptions in the one or more embodiments of the apparatus for training the speech recognition model provided below may be found in the foregoing description of the method of training the speech recognition model, and details are not described herein.

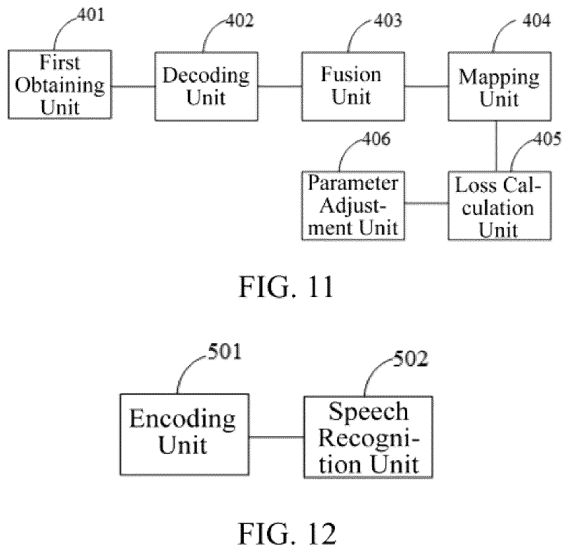

The present embodiment also provides an apparatus for training a speech recognition model, which may be specifically integrated in a terminal device or a server. For example, as shown in FIG. 11, the apparatus for training the speech recognition model may include:
a first obtaining unit 401, configured to obtain an encoded vector sequence output by an encoder of the speech recognition model after a speech sequence sample is processed through the encoder;
a decoding unit 402, configured to decode the encoded vector sequence through a decoding network of the speech recognition model to obtain a decoded vector sequence;
a fusion unit 403, configured to perform vector fusion on the encoded vector sequence and the decoded vector sequence through the decoding network to obtain a fused vector sequence;
a mapping unit 404, configured to perform mapping processing on the fused vector sequence through the decoding network to obtain a mapped vector sequence;
a loss calculation unit 405, configured to determine a first loss for the speech sequence sample based on the mapped vector sequence and a label sequence of the speech sequence sample; and
a parameter adjustment unit 406 configured to adjust the network parameters of the encoder in the speech recognition model based on the first loss to complete training of the speech recognition model.

In some embodiments, the fusion unit 403 may include:
an expansion subunit configured to expande decoded vector in the decoded vector sequence in quantity through the decoding network to obtain an expanded decoded vector sequence; and
an concatenation subunit is configured to perform vector concatenation on the expanded decoded vector sequence and the encoded vector sequence to obtain the fused vector sequence under the condition that a number of decoded vectors of the expanded decoded vector sequence is equal to a number of time frames of the encoded vector of the encoded vector sequence.

In some embodiments, the expansion subunit may be configured to:
copying the decoded vector in the decoded vector sequence through the decoding network to obtain a copy vector; and
interpolating the copy vector into a position in the decoded vector sequence adjacent to the decoded vector to obtain an expanded decoded vector sequence.

In some embodiments, the decoding unit 402 may include:
a first decoding subunit configured to perform decoding processing on a first encoded vector sequence output by a first network layer of the encoder by the decoding network to obtain a first decoded vector sequence.

In some embodiments, the fusion unit 403 may include:
a first fusion subunit configured to performing the vector fusion on the first encoded vector sequence and a second encoded vector sequence output by a second network layer of the encoder through the decoding network to obtain the fused vector sequence.

In some embodiments, the training apparatus may further include:
a first calculation unit configured to calculate a second loss based on the difference between the mapped vector sequence and the second encoded vector sequence; and
a first adjusting unit configured to adjust a network parameter of the encoder based on the second loss.

In some embodiments, the training apparatus may further include:
a second obtaining unit, configured to obtain a third encoded vector sequence output by a third network layer of the encoder during processing of the speech sequence sample by the encoder, and perform a posterior probability calculation based on the third encoded vector sequence to obtain a posterior probability sequence;
a determining unit configured to determine a mask position corresponding to an attention mechanism in the encoder based on a posterior probability sequence; and
a processing unit configured to perform encoding processing by the first network layer and the second network layer of the encoder based on the mask position.

In some embodiments, the determining unit may include:
a first determining subunit configured to determine probability spikes in the posterior probability sequence;
a reduction subunit configured to reduce a number of the probability spikes in the posterior probability sequence to obtain a reduced posterior probability sequence; and
a second determining subunit configured to determine the mask position corresponding to the attention mechanism in the encoder based on the reduced posterior probability sequence.

In some embodiments, the training apparatus may further include:
a second calculation unit configured to calculate a third loss based on the reduced posterior probability sequence and the label sequence; and
a second adjusting unit configured to adjust the network parameters of the encoder based on the third loss.

In some embodiments, decoding unit 402 may include:
a second decoding subunit configured to perform decoding processing on a second encoded vector sequence output by a second network layer of the encoder through the decoding network to obtain a second decoded vector sequence; and
In some embodiments, the fusion unit 403 may include:
a second fusion subunit configured to perform vector fusion on the second encoded vector sequence and the second decoded vector sequence through the decoding network to obtain the fused vector sequence.

In some embodiments, the apparatus may further include:
a third calculation unit configured to calculate a fourth loss based on the decoded vector sequence and the label sequence of the speech sequence sample; and
a third adjusting unit configured to adjust network parameters of the encoder based on the fourth loss.

Using the apparatus for training the speech recognition model, a first obtaining unit is configured to obtain an encoded vector sequence output by an encoder of the speech recognition model after a speech sequence sample is processed through the encoder. A decoding unit is configured to decode the encoded vector sequence through a decoding network of the speech recognition model to obtain a decoded vector sequence. A fusion unit is configured to perform vector fusion on the encoded vector sequence and the decoded vector sequence through the decoding network to obtain a fused vector sequence. A mapping unit is configured to perform mapping processing on the fused vector sequence through the decoding network to obtain a mapped vector sequence. A loss calculation unit is configured to determine a first loss for the speech sequence sample based on the mapped vector sequence and a label sequence of the speech sequence sample. A parameter adjustment unit is configured to adjust the network parameters of the encoder in the speech recognition model based on the first loss to complete training of the speech recognition model. The first loss is obtained based on the fused vector sequence of the encoded vector sequence and the decoded vector sequence. Therefore, after the encoder is trained based on the first loss, the output of the encoder may be aligned with the decoded vector sequence, so that the encoder learns part of the knowledge of the decoding network, so that the context understanding capability of the encoder to the speech sequence is significantly enhanced, the recognition capability of the speech recognition model is improved, and the end-to-end speech recognition capability of the speech recognition model is improved.

An embodiment also provides a speech recognition apparatus, which may be integrated in a terminal device or a server. For example, as shown in FIG. 12, the speech recognition apparatus may include:
an encoding unit 501, configured to encode a target speech sequence to be recognized by an encoder of a speech recognition model to obtain a target encoded vector sequence, where the speech recognition model is trained by the method of training the speech recognition model; and
a speech recognition unit 502 is configured to perform text recognition on the target encoded vector sequence by the decoder of the speech recognition model to obtain predicted text corresponding to the target speech sequence.

In some embodiments, the encoding unit 501 may include:
an input subunit configured to input the target speech sequence to be recognized into the encoder for encoding processing;
an obtaining subunit, configured to obtain an intermediate encoded vector sequence obtained during the encoding processing of the encoder, and performing a posterior probability calculation to obtain a posterior probability sequence;
a third determining subunit, configured to determine a mask position corresponding to an attention mechanism in the encoder based on the posterior probability sequence; and
a second processing subunit, configured to continue the encoding processing by the encoder based on the mask position and the intermediate encoded vector sequence to obtain a target encoded vector sequence output by the encoder.

With the above speech recognition apparatus, the encoding unit may encode the target speech sequence to be recognized by the encoder of the speech recognition model to obtain the target encoded vector sequence, and the speech recognition unit may perform text recognition on the target encoded vector sequence by the decoder of the speech recognition model to obtain the predicted text corresponding to the target speech sequence. The speech recognition model is trained by the method of training the speech recognition model according to an embodiment of the present disclosure. During the training process, the encoder continuously learns the knowledge of the decoding network. Therefore, after the speech recognition model has been trained, the context understanding ability of the encoder for the speech sequence is significantly enhanced, and the accuracy of the speech recognition may be improved.

On the basis of the same inventive concept, an embodiment of the present disclosure further provides a computer device, which may be a server or a terminal device. The computer device includes a memory and a processor, the memory storing a computer program executable by the processor to perform the following operations of the method of training the speech recognition model:
obtaining an encoded vector sequence output by an encoder of the speech recognition model after a speech sequence sample is processed through the encoder;
decoding the encoded vector sequence through a decoding network to obtain a decoded vector sequence;
performing vector fusion on the encoded vector sequence and the decoded vector sequence through the decoding network to obtain a fused vector sequence;
performing mapping processing on the fused vector sequence through the decoding network to obtain a mapped vector sequence;
determining a first loss for the speech sequence sample based on the mapped vector sequence and a label sequence of the speech sequence sample; and
adjusting the network parameters of the encoder in the speech recognition model based on the first loss to complete training of the speech recognition model.

The processor performs the operations of the speech recognition method when executing the computer program:
encoding a target speech sequence to be recognized by an encoder of a speech recognition model to obtain a target encoded vector sequence, where the speech recognition model is trained by the method of training the speech recognition model; and performing text recognition on the target encoded vector sequence by the decoder of the speech recognition model to obtain predicted text corresponding to the target speech sequence.

According to an embodiment, the output of the encoder is processed through the added decoding network to obtain a decoded result, and the network parameters of the encoder are adjusted based on the encoded result and the output of the encoder, so that the output of the adjusted encoder may be aligned with the fusion of the output of the decoding network and the output of the encoder, thereby improving the context information capability of the encoder and completing training for the speech recognition model.

Further, the predicted text is obtained by performing recognition processing on the target speech sequence to be recognized by the trained speech recognition model, so that the accuracy of end-to-end speech recognition may be improved.

Reference may be made to the previous embodiments for a specific implementation of each of the above operations, and details are not described herein.

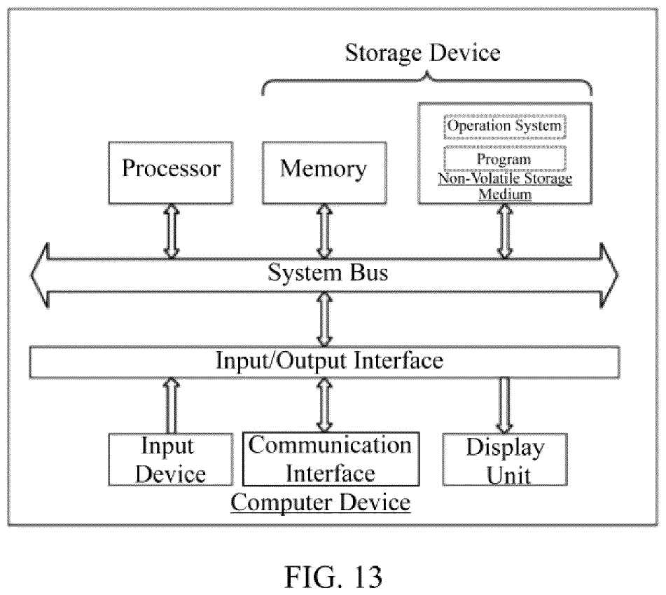

In an embodiment, the computer device is a terminal device, and an internal architecture diagram thereof may be shown in FIG. 13. The computer device includes a processor, a memory, an input/output interface, a communication interface, a display unit, and an input device. The processor, the memory and the input/output interface are connected through the system bus, and the communication interface, the display unit and the input device are connected to the system bus through the input/output interface. The processor of the computer device is configured to provide computing and control capabilities. The memory of the computer device includes a non-volatile storage medium and a memory. The non-volatile storage medium stores an operating system and a computer program. The memory provides an environment for the operation of an operating system and a computer program in a non-volatile storage medium. The input/output interface of the computer device is used for exchanging information between the processor and the external device. The communication interface of the computer device is used for wireline or wireless communication with external terminals, the wireless communication may be implemented by WIFI, mobile cellular network, near field communication (NFC) or other technology. The computer program is executed by a processor to implement a method of training a speech recognition model or a speech recognition method. The display unit of the computer device is used to form a visual picture, and may be a display screen, a projection device, or a virtual reality imaging device. The display screen may be a liquid crystal display screen or an electronic ink display screen. The input device of the computer device may be a touch layer covered on the display screen, or may be a key, a trackball, or a touch pad provided on a housing of the computer device, or may be an external keyboard, a touch pad, or a mouse.

It will be appreciated by those skilled in the art that the structure shown in FIG. 13 is a block diagram of only part of the architecture associated with the embodiments of the present disclosure, and does not constitute a limitation of the computer device to which the embodiments of the present disclosure are applied. The computer device may include more or less components than those shown in the figures, or may combine certain components, or have a different component arrangement.

Based on the same inventive concept, an embodiment of the present disclosure further provides a computer-readable storage medium, which may include a read-only memory (ROM), a random access memory (RAM), a magnetic disk, an optical disk, or the like.

Since the computer program stored in the computer readable storage medium may execute any method of training the speech recognition model or any speech recognition method according to an embodiments of the present disclosure, the beneficial effects that may be achieved by any method of training the speech recognition model or any speech recognition method according to an embodiments of the present disclosure may be realized. For details, refer to the foregoing embodiments, and details are not described herein.

Based on the same inventive concept, an embodiment of the present disclosure further provides a computer software or computer program including computer instructions stored in a computer readable storage medium. A processor of a computer device reads the computer instructions from a computer readable storage medium, the computer instructions is executable by the process to cause the computer device to perform the method according to any of the various alternative implementations of the above-described embodiments.

It should be noted that the object data (including but not limited to user equipment information, user personal information, and the like) and conversation data involved in the present disclosure are information and data that are authorized by a user or fully authorized by each party, and the collection, use, and processing of the related data need to comply with the relevant laws, regulations, and standards of the relevant countries and regions. It will be appreciated by those of ordinary skill in the art that all or part of the steps of implementing the methods according to an embodiment described above may be accomplished by a computer program which may be stored in a non-volatile computer readable storage medium and which, when executed, may include the operations of the methods according to any of the embodiments described above.

Any reference to a storage device, database, or other medium used in the embodiments provided herein may include at least one of non-volatile and volatile memory. The non-volatile memory may include Read-only Memory (ROM), magnetic tape, floppy disk, flash memory, optical memory, high-density embedded non-volatile memory, Resistive Random Access Memory (Re RAM), Magnetoresistive Random Access Memory (MRAM), Ferroelectric Random Access Memory (FRAM), Phase Change Memory (PCM), graphene memory, and the like. The volatile memory may include a Random Access Memory (RAM) or an external cache memory or the like. By way of illustration and not limitation, RAM may be in a variety of forms, such as Static Random Access Memory (SRAM) or Dynamic Random Access Memory (DRAM).

The databases in the embodiments provided herein may include at least one of a relational database and a non-relational database. The non-relational database may include a block chain-based distributed database or the like, and is not limited thereto. The processor in the embodiments provided herein may be a general purpose processor, a central processing unit, a graphics processor, a digital signal processor, a programmable logic unit, a quantum computing-based data processing logic unit, or the like, and is not limited thereto.

In the training method, the speech recognition method for the speech recognition model, the apparatus, the computer-readable storage medium, the computer device, and the computer software according to an embodiment described above, the description of each embodiment has its own focus, and the parts that are not described in detail in a certain embodiment may be referred to the relevant descriptions of other embodiments. It will be apparent to those skilled in the art that, for the convenience and brevity of the description, the method of training the speech recognition model, the speech recognition method, the apparatus, the computer-readable storage medium, the computer equipment and the computer software, and the specific working process of the corresponding units thereof, as well as the advantageous effects thereof, may be described with reference to the above embodiments, and details are not described herein.

Respective ones of the technical features in the above embodiments may be combined arbitrarily. For the sake of brevity, not all possible combinations of each of the technical features in the above embodiments have been described. However, the combinations of these technical features should be considered to be within the scope of the present description as long as they do not contradict each other.

Some embodiments of the present disclosure have been described in detail above. The description of the above embodiments merely aims to help to understand the present disclosure. Many modifications or equivalent substitutions with respect to the embodiments may occur to those of ordinary skill in the art based on the present disclosure. Thus, these modifications or equivalent substitutions shall fall within the scope of the present disclosure.

What is claimed is:

1. A method of training a speech recognition model having an encoder and a decoding network, comprising:
obtaining an encoded vector sequence obtained by the encoder processing a speech sequence sample;
decoding the encoded vector sequence by the decoding network to obtain a decoded vector sequence;
performing vector fusion on the encoded vector sequence and the decoded vector sequence by the decoding network to obtain a fused vector sequence;
performing mapping processing on the fused vector sequence by the decoding network to obtain a mapped vector sequence;
determining a first loss for the speech sequence sample based on the mapped vector sequence and a label sequence of the speech sequence sample; and
adjusting network parameters of the encoder based on the first loss to train the speech recognition model.

2. The method of claim 1, wherein the performing of the vector fusion on the encoded vector sequence and the decoded vector sequence comprises:
expanding decoded vectors of the decoded vector sequence in quantity to obtain an expanded decoded vector sequence; and
in response to determining that a number of decoded vectors of the expanded decoded vector sequence is equal to a number of time frames of encoded vectors of the encoded vector sequence, performing vector concatenation on the expanded decoded vector sequence and the encoded vector sequence to obtain the fused vector sequence.

3. The method of claim 2, wherein the expanding of the decoded vectors of the decoded vector sequence in quantity comprises: for each decoded vector of the decoded vectors of the decoded vector sequence,
copying the each decoded vector to obtain a copy vector; and
interpolating, in the decoded vector sequence, the copy vector to be adjacent to the each decoded vector.

4. The method of claim 1, wherein the encoder comprises a first network layer and a second network layer, and the encoded vector sequence comprises a first encoded vector sequence output by the first network layer and a second encoded vector sequence output by the second network layer;
the decoding of the encoded vector sequence by the decoding network to obtain the decoded vector sequence comprises: decoding the first encoded vector sequence by the decoding network to obtain a first decoded vector sequence; and
the performing of the vector fusion on the encoded vector sequence and the decoded vector sequence comprises: performing the vector fusion on the first decoded vector sequence and the second encoded vector sequence.

5. The method of claim 4, further comprising:
calculating a second loss based on a difference between the mapped vector sequence and the second encoded vector sequence; and
adjusting the network parameters of the encoder based on the second loss.

6. The method of claim 4, wherein the encoder further comprises a third network layer, and the encoded vector sequence further comprises a third encoded vector sequence output by the third network layer,
the method further comprising:
performing posterior probability calculation based on the third encoded vector sequence to obtain a posterior probability sequence;
determining a mask position corresponding to an attention mechanism in the encoder based on the posterior probability sequence; and
performing encoding processing based on the mask position by the first network layer and the second network layer.

7. The method of claim 6, wherein the determining of the mask position based on the posterior probability sequence comprises:
determining probability spikes in the posterior probability sequence;
reducing the probability spikes in the posterior probability sequence to obtain a reduced posterior probability sequence; and
determining the mask position based on the reduced posterior probability sequence.

8. The method of claim 7, further comprising:
calculating a third loss based on the reduced posterior probability sequence and the label sequence; and
adjusting the network parameters of the encoder based on the third loss.

9. The method of claim 1, wherein the encoder comprises a second network layer, and the encoded vector sequence comprises a second encoded vector sequence output by the second network layer;
the decoding of the encoded vector sequence by the decoding network to obtain the decoded vector sequence comprises: decoding the second encoded vector sequence by the decoding network to obtain a second decoded vector sequence; and
the performing of the vector fusion on the encoded vector sequence and the decoded vector sequence comprises: performing the vector fusion on the second encoded vector sequence and the second decoded vector sequence.

10. The method of claim 1, further comprising:
calculating a fourth loss based on the decoded vector sequence and the label sequence; and
adjusting the network parameters of the encoder based on the fourth loss.

11. A speech recognition method, comprising:
encoding a target speech sequence by an encoder of a speech recognition model to obtain a target encoded vector sequence, wherein the speech recognition model is trained by the method of claim 1; and
performing text recognition on the target encoded vector sequence by a decoder of the speech recognition model to obtain a predicted text corresponding to the target speech sequence.

12. The speech recognition method of claim 11, wherein the encoding of the target speech sequence by the encoder to obtain the target encoded vector sequence comprises:
encoding the target speech sequence by the encoder to obtain an intermediate encoded vector sequence;
performing posterior probability calculation based on the intermediate encoded vector sequence to obtain a posterior probability sequence;
determining a mask position corresponding to an attention mechanism in the encoder based on the posterior probability sequence; and
performing further encoding processing based on the mask position and the intermediate encoded vector sequence by the encoder to obtain the target encoded vector sequence.

13. A computer device, comprising:
a processor; and
a memory storing instructions executable by the processor to perform operations comprising:
obtaining an encoded vector sequence obtained by an encoder of a speech recognition model processing a speech sequence sample;
decoding the encoded vector sequence by a decoding network to obtain a decoded vector sequence;
performing vector fusion on the encoded vector sequence and the decoded vector sequence by the decoding network to obtain a fused vector sequence;
performing mapping processing on the fused vector sequence by the decoding network to obtain a mapped vector sequence;
determining a first loss for the speech sequence sample based on the mapped vector sequence and a label sequence of the speech sequence sample; and
adjusting network parameters of the encoder based on the first loss to train the speech recognition model.

14. The computer device of claim 13, wherein the performing of the vector fusion on the encoded vector sequence and the decoded vector sequence comprises:
expanding decoded vectors of the decoded vector sequence in quantity to obtain an expanded decoded vector sequence; and
in response to determining that a number of decoded vectors of the expanded decoded vector sequence is equal to a number of time frames of encoded vectors of the encoded vector sequence, performing vector concatenation on the expanded decoded vector sequence and the encoded vector sequence to obtain the fused vector sequence.

15. The computer device of claim 14, wherein the expanding of the decoded vectors of the decoded vector sequence in quantity comprises: for each decoded vector of the decoded vectors of the decoded vector sequence,
copying the each decoded vector to obtain a copy vector; and
interpolating, in the decoded vector sequence, the copy vector to be adjacent to the each decoded vector.

16. A computer device, comprising:
a processor; and
a memory storing instructions executable by the processor to perform operations comprising:
encoding a target speech sequence by an encoder of a speech recognition model to obtain a target encoded vector sequence, wherein the speech recognition model is trained by the method of claim 1; and
performing text recognition on the target encoded vector sequence by a decoder of the speech recognition model to obtain a predicted text corresponding to the target speech sequence.

17. The computer device of claim 16, wherein the encoding of the target speech sequence by the encoder to obtain the target encoded vector sequence comprises:
encoding the target speech sequence by the encoder to obtain an intermediate encoded vector sequence;
performing posterior probability calculation based on the intermediate encoded vector sequence to obtain a posterior probability sequence;
determining a mask position corresponding to an attention mechanism in the encoder based on the posterior probability sequence; and
performing further encoding processing based on the mask position and the intermediate encoded vector sequence by the encoder to obtain the target encoded vector sequence.

18. A non-transitory computer-readable storage medium storing instructions executable by a processor to perform the method of claim 1.

19. A non-transitory computer-readable storage medium storing instructions executable by a processor to perform the speech recognition method of claim 11.

20. A computer program product, comprising a computer program executable by a processor to perform the method of claim 1.
